(19) United States
(12) Patent Application Publication
(10) Pub. No.: US 2026/0214683 A1
(43) Pub. Date: Jul. 23, 2026

(54) SYMBOL ALLOCATION FOR MULTI-SLOT SCHEDULING IN A SIDELINK SYSTEM

(71) Applicant: QUALCOMM Incorporated, San Diego, CA (US)

(72) Inventors: Luanxia YANG, Beijing (CN); Jing SUN, San Diego, CA (US); Chih-Hao LIU, San Diego, CA (US); Changlong XU, Beijing (CN); Xiaoxia ZHANG, San Diego, CA (US); Giovanni CHISCI, San Diego, CA (US); Siyi CHEN, Beijing (CN); Shaozhen GUO, Beijing (CN); Hao XU, Beijing (CN)

(21) Appl. No.: 19/142,907

(22) PCT Filed: Feb. 16, 2023
(86) PCT No.: PCT/CN2023/076349

§ 371 Date: Jun. 24, 2025

(51) Int. Cl. H04W 72/25; H04W 72/1263

(52) U.S. Cl. CPC H04W 72/25; H04W 72/1263

(57) ABSTRACT

Methods, systems, and devices for wireless communication are described. The method may include a first user equipment (UE) receiving a first control signal that indicates a set of sidelink resources including a set of slots within a subcarrier. The set of slots may include a first set of symbols allocated for power control signaling and a second set of symbols allocated as gap symbols. Further, the UE may receive, based on receiving the first control signal, a second control signal including an indication of whether to receive a first data signal using one or both of the first set of symbols or the second set of symbols and receive the first data signal in accordance with the indication.

### CROSS REFERENCE

The present Application is a 371 national phase filing of International PCT Application No. PCT/CN2023/076349 by YANG et al., entitled “SYMBOL ALLOCATION FOR MULTI-SLOT SCHEDULING IN A SIDELINK SYSTEM,” filed Feb. 16, 2023, which is assigned to the assignee hereof, and which is expressly incorporated by reference in its entirety herein.

### FIELD OF TECHNOLOGY

The following relates to wireless communication, including symbol allocation for multi-slot scheduling in a sidelink system.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Some wireless communications systems may support sidelink communications between two or more UEs. To support sidelink communications, the two or more UEs may be configured with a set of sidelink resources. Once configured with the set of sidelink resources, a UE may reserve sidelink resources of the set of sidelink resources (e.g., via mode 1 or mode 2) for communication of sidelink signaling to another UE.

### SUMMARY

The described techniques relate to improved methods, systems, devices, and apparatuses that support symbol allocation for multi-slot scheduling in a sidelink system. For example, the described techniques provide for a user equipment (UE) to allocate a gap symbol or a power control symbol of one or more sidelink slots for data signaling during multi-slot sidelink scheduling. In some examples, a first UE may receive a first control signal that indicates a set of sidelink resources. The set of sidelink resources may include a set of slots within a subcarrier and the set of slots may include a first set of symbols allocated for power control (e.g., automatic gain control (AGC) symbols) and a second set of symbols allocated as gap symbols. Further, the first UE may receive a second control signal that include an indication of whether to receive a first data signal using one or both of the first set of symbols or the second set of symbols and the first UE may receive the first data signal from a second UE in accordance with the indication. The techniques as described herein may allow UEs to utilize gap symbols or symbols allocated for power control for sidelink data signaling during instances of multi-slot scheduling. Using these additional symbols for sidelink which may reduce overhead signaling when compared to other methods.

A method for wireless communication at a first UE is described. The method may include receiving a first control signal that indicates a set of sidelink resources including a set of multiple slots within a subcarrier, where the set of multiple slots includes a first set of symbols allocated for power control signaling and a second set of symbols allocated as gap symbols, receiving, based on receiving the first control signal, a second control signal including an indication of whether to receive a first data signal using one or both of the first set of symbols or the second set of symbols, and receiving the first data signal in accordance with the indication.

An apparatus for wireless communication at a first UE is described. The apparatus may include a processor, memory coupled with the processor, and instructions stored in the memory. The instructions may be executable by the processor to cause the apparatus to receive a first control signal that indicates a set of sidelink resources including a set of multiple slots within a subcarrier, where the set of multiple slots includes a first set of symbols allocated for power control signaling and a second set of symbols allocated as gap symbols, receive, based on receiving the first control signal, a second control signal including an indication of whether to receive a first data signal using one or both of the first set of symbols or the second set of symbols, and receive the first data signal in accordance with the indication.

Another apparatus for wireless communication at a first UE is described. The apparatus may include means for receiving a first control signal that indicates a set of sidelink resources including a set of multiple slots within a subcarrier, where the set of multiple slots includes a first set of symbols allocated for power control signaling and a second set of symbols allocated as gap symbols, means for receiving, based on receiving the first control signal, a second control signal including an indication of whether to receive a first data signal using one or both of the first set of symbols or the second set of symbols, and means for receiving the first data signal in accordance with the indication.

A non-transitory computer-readable medium storing code for wireless communication at a first UE is described. The code may include instructions executable by a processor to receive a first control signal that indicates a set of sidelink resources including a set of multiple slots within a subcarrier, where the set of multiple slots includes a first set of symbols allocated for power control signaling and a second set of symbols allocated as gap symbols, receive, based on receiving the first control signal, a second control signal including an indication of whether to receive a first data signal using one or both of the first set of symbols or the second set of symbols, and receive the first data signal in accordance with the indication.

In some examples of the method, apparatuses, and non-transitory computer-readable medium described herein, receiving the second control signal may include operations, features, means, or instructions for receiving control information scheduling the first UE to receive the first data signal using a first slot of the set of multiple slots and a second slot of the set of multiple slots, where the first slot may be before the second slot in time.

In some examples of the method, apparatuses, and non-transitory computer-readable medium described herein, receiving the first data signal may include operations, features, means, or instructions for receiving a first portion of the first data signal using a subset of the first set of symbols corresponding to the first slot in accordance with the indication signaling to receive the first data signal using the first set of symbols.

In some examples of the method, apparatuses, and non-transitory computer-readable medium described herein, receiving the first data signal may include operations, features, means, or instructions for receiving a second portion of the first data signal using a subset of the first set of symbols corresponding to the second slot in accordance with the indication signaling to receive the first data signal using the first set of symbols.

In some examples of the method, apparatuses, and non-transitory computer-readable medium described herein, receiving the first data signal may include operations, features, means, or instructions for receiving a first portion of the first data signal using a subset of the second set of symbols corresponding to the second slot in accordance with the indication signaling to receive the first data signal using the second set of symbols.

In some examples of the method, apparatuses, and non-transitory computer-readable medium described herein, receiving the first data signal may include operations, features, means, or instructions for receiving a second portion of the first data signal using a subset of the second set of symbols corresponding to the first slot in accordance with the indication signaling to receive the first data signal using the second set of symbols.

In some examples of the method, apparatuses, and non-transitory computer-readable medium described herein, the first slot may be associated with a first frequency domain resource allocation (FDRA) and the second slot may be associated with a second FDRA different from the first FDRA and the second control signal includes a first bit indicating whether to receive a first portion of the first data signal using a subset of the first set of symbols corresponding to the first slot, a second bit indicating whether to receive a second portion of the first data signal using a subset of the second set of symbols corresponding to the first slot, a third bit indicating whether to receive a third portion of the first data signal using a subset of the first set of symbols corresponding to the second slot, and a fourth bit indicating whether to receive a fourth portion of the first data signal using a subset of the second set of symbols corresponding to the second slot.

In some examples of the method, apparatuses, and non-transitory computer-readable medium described herein, the second control signal includes a first bit indicating whether to receive a first a portion of the first data signal using the first set of symbols and a second bit indicating whether to receive a second portion of the first data signal using the second set of symbols.

In some examples of the method, apparatuses, and non-transitory computer-readable medium described herein, receiving the second control signal may include operations, features, means, or instructions for receiving first control information scheduling the first UE to receive the first data signal using one or more first slots of the set of multiple slots and second control information scheduling a second UE to receive a second data signal using one or more second slots of the set of multiple slots.

In some examples of the method, apparatuses, and non-transitory computer-readable medium described herein, the second control signal includes an indication of whether to receive the second data signal using one or both of the first set of symbols or the second set of symbols.

In some examples of the method, apparatuses, and non-transitory computer-readable medium described herein, the second control signal includes a first bit indicating whether to receive a first portion of the first data signal using a first subset of the first set of symbols, a second bit indicating whether to receive a second portion of the first data signal using a first subset of the second set of symbols, a third bit indicating whether to receive a first portion of the second data signal using a second subset of the first set of symbols, and a fourth bit indicating whether to receive a second portion of the second data signal using a second subset of the second set of symbols.

In some examples of the method, apparatuses, and non-transitory computer-readable medium described herein, receiving the first data signal may include operations, features, means, or instructions for receiving the first data signal using a subset of the second set of symbols corresponding to a slot of the subset of slots in accordance with the indication signaling to receive the first data signal using the second set of symbols.

In some examples of the method, apparatuses, and non-transitory computer-readable medium described herein, a subset of the set of multiple slots includes a third set of symbols allocated for sidelink feedback and the method, apparatuses, and non-transitory computer-readable medium may include further operations, features, means, or instructions for receiving filler signaling using a subset of the second set of symbols corresponding to a slot of the subset of slots.

In some examples of the method, apparatuses, and non-transitory computer-readable medium described herein, the second control signal includes type 1 sidelink control information (SCI) or type 2 SCI.

A method for wireless communication at a first UE is described. The method may include receiving a first control signal that indicates a set of sidelink resources including a set of multiple slots within a subcarrier, where the set of multiple slots includes a first set of symbols allocated for power control signaling and a second set of symbols allocated as gap symbols, transmitting, based on receiving the first control signal, a second control signal including an indication of whether a second UE is to receive a first data signal using one or both of the first set of symbols or the second set of symbols, and transmitting the first data signal in accordance with the indication.

An apparatus for wireless communication at a first UE is described. The apparatus may include a processor, memory coupled with the processor, and instructions stored in the memory. The instructions may be executable by the processor to cause the apparatus to receive a first control signal that indicates a set of sidelink resources including a set of multiple slots within a subcarrier, where the set of multiple slots includes a first set of symbols allocated for power control signaling and a second set of symbols allocated as gap symbols, transmit, based on receiving the first control signal, a second control signal including an indication of whether a second UE is to receive a first data signal using one or both of the first set of symbols or the second set of symbols, and transmit the first data signal in accordance with the indication.

Another apparatus for wireless communication at a first UE is described. The apparatus may include means for receiving a first control signal that indicates a set of sidelink resources including a set of multiple slots within a subcarrier, where the set of multiple slots includes a first set of symbols allocated for power control signaling and a second set of symbols allocated as gap symbols, means for transmitting, based on receiving the first control signal, a second control signal including an indication of whether a second UE is to receive a first data signal using one or both of the first set of symbols or the second set of symbols, and means for transmitting the first data signal in accordance with the indication.

A non-transitory computer-readable medium storing code for wireless communication at a first UE is described. The code may include instructions executable by a processor to receive a first control signal that indicates a set of sidelink resources including a set of multiple slots within a subcarrier, where the set of multiple slots includes a first set of symbols allocated for power control signaling and a second set of symbols allocated as gap symbols, transmit, based on receiving the first control signal, a second control signal including an indication of whether a second UE is to receive a first data signal using one or both of the first set of symbols or the second set of symbols, and transmit the first data signal in accordance with the indication.

In some examples of the method, apparatuses, and non-transitory computer-readable medium described herein, transmitting the second control signal may include operations, features, means, or instructions for transmitting control information scheduling the second UE to receive the first data signal using a first slot of the set of multiple slots and a second slot of the set of multiple slots, where the first slot may be before the second slot in time.

In some examples of the method, apparatuses, and non-transitory computer-readable medium described herein, transmitting the first data signal may include operations, features, means, or instructions for transmitting a first portion of the first data signal using a subset of the first set of symbols corresponding to the first slot in accordance with the indication signaling the second UE to receive the first data signal using the first set of symbols.

In some examples of the method, apparatuses, and non-transitory computer-readable medium described herein, transmitting the first data signal may include operations, features, means, or instructions for transmitting a second portion of the first data signal using a subset of the first set of symbols corresponding to the second slot in accordance with the indication signaling the second UE to receive the first data signal using the first set of symbols.

In some examples of the method, apparatuses, and non-transitory computer-readable medium described herein, transmitting the first data signal may include operations, features, means, or instructions for transmitting a first portion of the first data signal using subset of the second set of symbols corresponding to the second slot in accordance with the indication signaling the second UE to receive the first data signal using the second set of symbols.

In some examples of the method, apparatuses, and non-transitory computer-readable medium described herein, transmitting the first data signal may include operations, features, means, or instructions for transmitting a second portion of the first data signal using a subset of the second set of symbols corresponding to the first slot in accordance with the indication signaling the second UE to receive the first data signal using the second set of symbols.

In some examples of the method, apparatuses, and non-transitory computer-readable medium described herein, the first slot may be associated with a first FDRA and the second slot may be associated with a second FDRA different from the first FDRA and the second control signal includes a first bit indicating whether the second UE may be to receive a first portion of the first data signal using a subset of the first set of symbols corresponding to the first slot, a second bit indicating whether the second UE may be to receive a second portion of the first data signal using a subset of the second set of symbols corresponding to the first slot, a third bit indicating whether the second UE may be to receive a third portion of the first data signal using a subset of the first set of symbols corresponding to second slot, and a fourth bit indicating whether the second UE may be to receive a fourth portion of the first data signal using a second subset of the second set of symbols corresponding to the second slot.

In some examples of the method, apparatuses, and non-transitory computer-readable medium described herein, the second control signal includes a first bit indicating whether the second UE may be to receive a first portion the first data signal using the first set of symbols and a second bit indicating whether the second UE may be to receive a second portion of the first data signal using the second set of symbols.

In some examples of the method, apparatuses, and non-transitory computer-readable medium described herein, transmitting the second control signal may include operations, features, means, or instructions for transmitting first control information scheduling the second UE to receive the first data signal using one or more first slots of the set of multiple slots and second control information scheduling a third UE to receive second data signal using one or more second slots of the set of multiple slots.

In some examples of the method, apparatuses, and non-transitory computer-readable medium described herein, the second control signal includes an indication of whether the third UE may be to receive the second data signal using one or both of the first set of symbols or the second set of symbols.

In some examples of the method, apparatuses, and non-transitory computer-readable medium described herein, the second control signal includes a first bit indicating whether the second UE may be to receive a first portion of the first data signal using a first subset of the first set of symbols, a second bit indicating whether the second UE may be to receive a second portion of the first data signal using a first subset of the second set of symbols, a third bit whether the third UE may be to receive a first portion of the second data signal using a second subset of the first set of symbols, and a fourth bit indicating whether the third UE may be to receive a second portion of the second data signal using a second subset of the second set of symbols.

In some examples of the method, apparatuses, and non-transitory computer-readable medium described herein, transmitting the first data signal may include operations, features, means, or instructions for transmitting the first data signal using a subset of the second set of symbols corresponding to a slot of the subset of slots in accordance with the indication signaling the second UE receive the first data signal using the second set of symbols.

In some examples of the method, apparatuses, and non-transitory computer-readable medium described herein, a subset of the set of multiple slots includes a third set of symbols allocated for sidelink feedback and the method, apparatuses, and non-transitory computer-readable medium may include further operations, features, means, or instructions for transmitting filler signaling using a subset of the second set of symbols corresponding to a slot of the subset of slots.

In some examples of the method, apparatuses, and non-transitory computer-readable medium described herein, the second control signal includes type 1 SCI or type 2 SCI.

### BRIEF DESCRIPTION OF THE DRAWINGS

FIGS. 1 and 2 illustrate examples of a wireless communications system that supports symbol allocation for multi-slot scheduling in a sidelink system in accordance with one or more aspects of the present disclosure.

FIGS. 3, 4, and 5 illustrate examples of a sidelink allocation scheme that supports symbol allocation for multi-slot scheduling in a sidelink system in accordance with one or more aspects of the present disclosure.

FIG. 6 illustrates an example of a process flow that supports symbol allocation for multi-slot scheduling in a sidelink system in accordance with one or more aspects of the present disclosure.

FIGS. 7 and 8 illustrate block diagrams of devices that support symbol allocation for multi-slot scheduling in a sidelink system in accordance with one or more aspects of the present disclosure.

FIG. 9 illustrates a block diagram of a communications manager that supports symbol allocation for multi-slot scheduling in a sidelink system in accordance with one or more aspects of the present disclosure.

FIG. 10 illustrates a diagram of a system including a device that supports symbol allocation for multi-slot scheduling in a sidelink system in accordance with one or more aspects of the present disclosure.

FIGS. 11 through 16 illustrate flowcharts showing methods that support symbol allocation for multi-slot scheduling in a sidelink system in accordance with one or more aspects of the present disclosure.

### DETAILED DESCRIPTION

A wireless communications system may support sidelink communication. Sidelink communication may be described as direct wireless communication between two or more user equipment (UEs). UEs that are involved in sidelink communication may be configured with a sidelink resources pool. The sidelink resource pool may include multiple slots and each slot of the multiple slots may include a set of symbols. In some examples, different symbols of the slot may be allocated for different types of signaling. For example, different subsets of symbols of a slot may be allocated for data signaling, control signaling, power control signaling (e.g., automatic gain control (AGC) symbols), feedback signaling, or no signaling (e.g., gap symbols). In a mode 2 of sidelink operation, a transmitting UE may select resources from the resource pool over which to transmit sidelink signaling to a receiving UE and transmit sidelink control information (SCI) to the receiving UE indicating the selected resources. Further, in some examples, the SCI may schedule multiple slots. If sidelink signaling is transmitted in adjacent slots, the gap symbols and the symbols allocated for power control signals may be unnecessary and as such, including these symbols in the slot may increase overhead signaling.

As described herein, the receiving UE may determine whether to utilize one or both of a gap symbol or an AGC symbol of a sidelink slot to receive sidelink signaling from a transmitting UE. In some examples, UEs participating in sidelink communications may receive a first control signal indicating a sidelink resource pool. The sidelink resource pool may include multiple slots and the multiple slots may include a first set of symbols including gap symbols and a second set of symbols including AGC symbols. Further, the receiving UE may receive a second control signal (e.g., SCI) scheduling the receiving UE to receive data signaling over one or more slots. Further, the second control signal may include an indication of whether to utilize one or both of the AGC symbols or the gap symbols of the one or more scheduled slots for reception of the data signaling.

In one example, the indication may include one or more bits. A first bit may correspond to the AGC symbol(s) and a second bit may correspond to the gap symbol(s). A logic value of the first bit may indicate whether an AGC symbol of the one or more scheduled slots will be used for reception of the data signaling and a logic value of the second bit may indicate whether a gap symbol of the one or more scheduled slots may be used for reception of the data signaling. In some examples, the second control signal may schedule multiple UEs across multiple slots. In such examples, the indication may include a bit map. The bit map may indicate, to each scheduled UE, whether an AGC symbol of the scheduled slots may be used for reception of the data signaling and whether a gap symbol of the scheduled slots may be used for reception of the data signaling. Using such techniques may allow UEs to utilize gap symbols and AGC symbols for data signaling in situations when gap symbols and AGC symbols may not be needed (e.g., when data signaling is scheduled across multiple slots), which may increase the efficiency of the system and reduce unnecessary overhead when compared to other methods.

Aspects of the disclosure are initially described in the context of wireless communications systems. Aspects of the disclosure are further illustrated by and described with reference to apparatus diagrams, system diagrams, and flowcharts that relate to symbol allocation for multi-slot scheduling in a sidelink system.

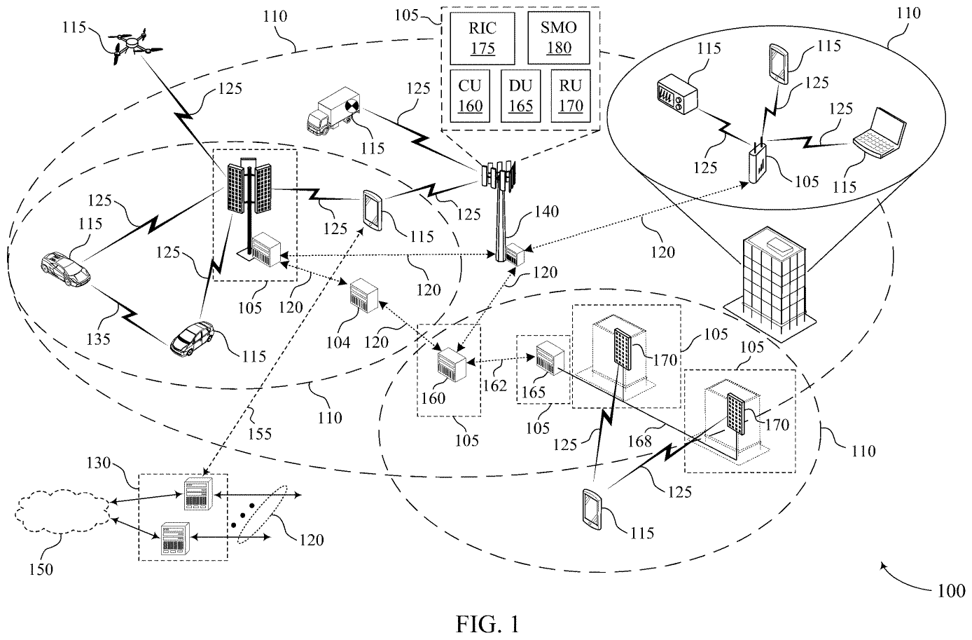

FIG. 1 illustrates an example of a wireless communications system 100 that supports symbol allocation for multi-slot scheduling in a sidelink system in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (VIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support symbol allocation for multi-slot scheduling in a sidelink system as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

As described herein, the UE 115 may allocate a gap symbol or a power control symbol of one or more sidelink slots for data signaling during multi-slot sidelink scheduling. In some examples, a first UE 115 may receive a first control signal that indicates a set of sidelink resources. The set of sidelink resources may include a set of slots within a subcarrier and the set of slots may include a first set of symbols allocated for power control (e.g., AGC symbols) and a second set of symbols allocated as gap symbols. Further, the first UE 115 may receive a second control signal that include an indication of whether to receive a first data signal using one or both of the first set of symbols or the second set of symbols and the first UE 115 may receive the first data signal from a second UE 115 in accordance with the indication. The methods as described herein may allow UEs 115 to utilize symbols allocated for gap or symbols allocated for power control for sidelink data signaling during instances of multi-slot scheduling which may reduce overhead signaling when compared to other methods.

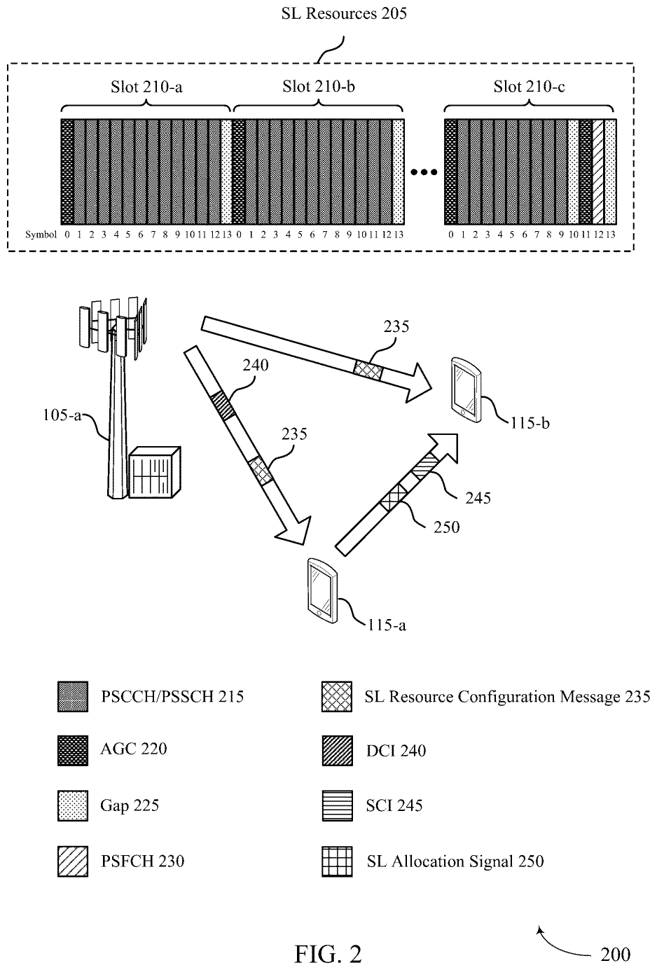

FIG. 2 illustrates an example of a wireless communications system 200 that supports symbol allocation for multi-slot scheduling in a sidelink system in accordance with one or more aspects of the present disclosure. In some examples, the wireless communications system 200 may implement aspects of a wireless communications system 100. For example, the wireless communications system 200 may include a UE 115-a and a UE 115-b which may be examples of UEs 115 as described with reference to FIG. 1. Additionally, the wireless communications system 200 may include a network entity 105-a which may be an example of a network entity 105 as described with reference to FIG. 1.

In some examples, the wireless communications system 200 may support sidelink communication. Sidelink communication may be described as communication between two or more UEs 115. In order to support sidelink communications, the network entity 105-a may assign sidelink resources 205 (e.g., a sidelink transmission and reception resource pool) to the UEs 115 participating in the sidelink communications. For example, the network entity 105-a may transmit a sidelink resource configuration message 235 to the UE 115-a and the UE 115-b. The sidelink resource configuration message 235 may include an indication of the set of sidelink resources 205. The set of sidelink resources 205 may include time resources (e.g., one or more slots 210) and frequency resources (e.g., at least one sub-channel). Each slot 210 may be divided into a set of symbols (e.g., 14 symbols).

Different subsets of the set of symbols of a slot 210 may be allocated for a different type of signaling. For example, slots 210 of the set of sidelink resources 205 may include subsets of symbols allocated for AGC 220, physical sidelink control channel (PSCCH)/physical sidelink shared channel (PSSCH) 215, and gap 225. A subset of symbols allocated for AGC 220 may be used for level control in a UE 115 receiving a sidelink communication, a subset of symbols allocated for PSCCH may be used for transmission or reception of SCI, a subset of symbols allocated for PSSCH may be used for reception or transmission of sidelink data, and a subset of symbols allocated for gap 225 may be used for timing adjustment or to facilitate switching between sidelink reception and sidelink transmission. As shown in FIG. 2, a slot 210-a and a slot 210-b may include a symbol 0 (or a first symbol) allocated for AGC 220, symbols 1 through 12 allocated for PSCCH/PSSCH 215, and a symbol 13 (or a last symbol) allocated for gap 225.

Further, one or more slots 210 of the set of sidelink resources 205 may include a subset of symbols allocated for PSFCH 230. The subset of the symbols allocated for PSFCH 230 may be used to rely feedback related to sidelink communication. As shown in FIG. 2, the slot 210-c may include a symbol 0 (or a first symbol) and a symbol 11 allocated for AGC 220, symbols 1 through 9 allocated for PSCCH/PSSCH 215, and a symbol 13 (or a last symbol) and a symbol 10 allocated for gap 225. In some examples, the slots 210 including the subset of symbols allocated for PSFCH 230 may be associated with a periodicity. For example, a slot 210 including a subset of symbols allocated for PSFCH 230 may occur every 1, 2, or 4 slots or not at all (e.g., a periodicity of 0 slots).

A transmitting UE (e.g., the UE 115-a) may allocate resources for transmission of a sidelink communication to a receiving UE (e.g., the UE 115-b) using one of two different modes. In a mode 1 of operation, the network entity 105 may allocate resources for sidelink communications between the UE 115-a and the UE 115-b. For example, the network entity 105-a may transmit downlink control information (DCI) to the UE 115-a indicating resources over which to transmit a sidelink communication to the UE 115-b. In a mode 2 of operation, the UE 115-a may autonomously select resource over which to transmit a sidelink communication to the UE 115-b using a sensing operation. In some examples, the UE 115-a may transmit SCI 245 to the UE 115-b. SCI 245 may include a first stage SCI and a second stage SCI. The first stage SCI may include an indication of the resources over which the UE 115-a may transmit the sidelink communication to the UE 115-b, a resource reservation period, a PSSCH demodulation reference signal (DMRS) pattern, second stage SCI format (or a size of the second stage SCI), an amount of resources for the second stage SCI, a number of DMRS ports, or a modulation and coding scheme (MCS). The second stage SCI may include information for decoding the sidelink communication (e.g., PSSCH) such as a 16-bit L1 destination bit, 8-bit L1 source identifier (ID), HARQ process ID, a new data indicator (NDI), or a redundancy version (RV).

In some examples, the UE 115-a may be scheduled (e.g., via mode 1 or mode 2) to transmit a sidelink communication to the UE 115-b over multiple slots 210 (or mini-slots). For example, the UE 115-a may be scheduled to transmit a sidelink communication over at least a portion of the resources of the slot 210-a and the slot 210-b. If the UE 115-a is transmitting over adjacent slots 210, one or both of the subset of symbols allocated for gap 225 and the subset of symbols allocated for AGC 220 between the adjacent slots 210 may not be needed. That is, there may be no need for any timing adjustments or level control if the UE 115-a is transmitting over adjacent slots 210. As such, using the symbols allocated for gap and the symbols allocated for AGC may increase overhead signaling (e.g., 2/14 symbol overhead for the slot 210-a and the slot 210-b and 4/14 symbol overhead for the slot 210-c) in instances of multi-slot scheduling.

As described herein, if the UE 115-a receives data to be transmitted over multiple slots 210, the UE 115-a may utilize one or both of the subset of symbols allocated for gap 225 or the subset of symbols allocated for AGC 220 of the multiple slots 210 for transmitting a sidelink communication including the data. In the example of FIG. 2, the UE 115-a may be scheduled (e.g., via mode 1 or mode 2) to transmit the sidelink communication to the UE 115-b using the slot 210-a and the slot 210-b. To inform the UE 115-b of the impending sidelink communication, the UE 115-a may transmit SCI 245 to the UE 115-b. Further, the UE 115-a may transmit a sidelink allocation signal 250 to the UE 115-b. In some examples, the sidelink allocation signal 250 may be included in the SCI 245 (e.g., first stage SCI or second stage SCI). The sidelink allocation signal 250 may indicate whether the UE 115-b will utilize one or both of the subset of symbols allocated for gap 225 or the subset of symbols allocated for AGC 220 to receive the sidelink communication from the UE 115-b.

More specifically, the sidelink allocation signal 250 may include an indication of whether a symbol allocated for AGC 220 of a first scheduled slot 210 will be used for PSSCH and additionally, whether a symbol allocated for gap 225 of a last scheduled slot 210 will be used for PSSCH. For example, the sidelink allocation signal 250 may indicate whether the symbol 0 (or the first symbol) of the slot 210-a will be used for PSSCH (e.g., used to receive a first portion of the sidelink communication) and additionally, indicate whether the symbol 13 (or the last symbol) of the slot 210-b will be used for PSSCH (e.g., used to receive a second portion of the sidelink communication). In such examples, all other symbols allocated for AGC 220 of the scheduled slots 210 (e.g., the symbol 0 of slot 210-b) and all other symbols allocated for gap 225 of the scheduled slots 210 (e.g., the symbol 13 of the slot 210-a) may be used for PSSCH.

In another example, the sidelink allocation signal 250 may include an indication of whether a subset of symbols allocated for AGC 220 of each scheduled slot 210 will be used for PSSCH and additionally, indicate whether a subset of symbols allocated for gap 225 of each scheduled slot 210 will be used for PSSCH. In the event that the UE 115-a is scheduled to transmit a sidelink communication to the UE 115-b using the slot 210-a and the slot 210-b, the sidelink allocation signal 250 may indicate whether the symbol 0 of the slot 210-a and the symbol 0 of the slot 210-b will be used for PSSCH and additionally, indicate whether the symbol 13 of the slot 210-a and the symbol 13 of the slot 210-b will be used for PSSCH.

In another example, the UE 115-a may be scheduled to transmit a sidelink communication to a UE 115-b using multiple adjacent slots 210 and the multiple slots 210 may be associated with different frequency resources (e.g., associated with different FDRAs). For example, the UE 115-a may be scheduled to transmit a sidelink communication to the UE 115-b using the slot 210-a, the slot 210-b, and a different slot 210 (e.g., a slot 210 that is adjacent to and occurs after the slot 210-b). The slot 210-a and the slot 210-b may correspond to a first FDRA and the different slot 210 may correspond to a second FDRA different from the first FDRA. In such example, the UE 115-a may transmit the sidelink allocation signal 250 to the UE 115-b. The sidelink allocation signal 250 may indicate whether the symbol 0 (or the first symbol) of the slot 210-a will be used for PSSCH reception by the UE 115-b and additionally, indicate whether the symbol 13 (or the last symbol) of the slot 210-b will be used for PSSCH reception by the UE 115-b. Further, the sidelink allocation signal 250 may indicate whether the symbol 0 (or the first symbol) of the different slot 210 will be used for PSSCH reception by the UE 115-b and additionally, indicate whether the symbol 13 (or the last symbol) of the different slot 210 will be used for PSSCH reception by the UE 115-b. All other symbols allocated for AGC 220 of the scheduled slots 210 and all other symbols allocated for gap 225 of the scheduled slots 210 may be used for PSSCH reception.

In another example, the UE 115-a may be scheduled to transmit a sidelink communication to a UE 115-b using multiple adjacent slots 210 and the multiple slots 210 may be associated with different frequency resources (e.g., associated with different FDRAs). For example, the UE 115-a may be scheduled to transmit a sidelink communication to the UE 115-b using the slot 210-a, the slot 210-b, and a different slot 210 (e.g., a slot 210 that is adjacent to and occurs after the slot 210-b). The slot 210-a and the slot 210-b may correspond to a first FDRA and the different slot 210 may correspond to a second FDRA different from the first FDRA. In such example, the UE 115-a may transmit the sidelink allocation signal 250 to the UE 115-b. The sidelink allocation signal 250 may indicate whether the symbol 0 of the slot 210-a and the symbol 0 of the slot 210-b will be used for PSSCH reception by the UE 115-b and additionally, indicate whether the symbol 13 of the slot 210-a and the symbol 13 of the slot 210-b will be used for PSSCH reception by the UE 115-b. Further, the sidelink allocation signal 250 may indicate whether the symbol 0 of the different slot 210 will be used for PSSCH reception by the UE 115-b and additionally, indicate whether the symbol 13 of the different slot 210 will be used for PSSCH reception by the UE 115-b.

In another example, the UE 115-a may be scheduled to transmit sidelink communications to multiple UEs 115 using multiple adjacent slots 210. For example, the UE 115-a may be scheduled to transmit a sidelink communication to the UE 115-b using the slot 210-a and the slot 210-b and additionally, the UE 115-a may be scheduled to transmit a sidelink communication to a different UE 115 (e.g., different from the UE 115-b) using a different slot 210 that is adjacent to and occurs after the slot 210-b. In such examples, the UE 115-a may transmit the sidelink allocation signal 250 to both the UE 115-b and the different UE 115. The sidelink allocation signal 250 may indicate whether the symbol 0 (or the first symbol) of the slot 210-a will be used for PSSCH reception by the UE 115-b and additionally, indicate whether the symbol 13 (or the last symbol) of the slot 210-b will be used for PSSCH reception by the UE 115-b. Further, the sidelink allocation signal 250 may indicate whether the symbol 0 (or the first symbol) of the different slot 210 will be used for PSSCH reception by the different UE 115 and additionally, indicate whether the symbol 13 (or the last symbol) of the different slot 210 will be used for PSSCH reception by the different UE 115. All other symbols allocated for AGC 220 of the scheduled slots 210 and all other symbols allocated for gap 225 of the scheduled slots 210 may be used for PSSCH.

In some examples, the UE 115-a may be scheduled to transmit sidelink communications to multiple UEs 115 using multiple adjacent slots 210. For example, the UE 115-a may be scheduled to transmit a sidelink communication to the UE 115-b using the slot 210-a and the slot 210-b and transmit a sidelink communication to a different UE 115 (e.g., different from the UE 115-b) using a different slot 210 that is adjacent to and occurs after the slot 210-b. In such examples, the UE 115-a may transmit the sidelink allocation signal 250 to both the UE 115-b and the different UE 115. The sidelink allocation signal 250 may indicate whether the symbol 0 of the slot 210-a and the symbol 0 of the slot 210-b will be used for PSSCH reception by the UE 115-b and additionally, indicate whether the symbol 13 of the slot 210-a and the symbol 13 of the slot 210-b will be used for PSSCH reception by the UE 115-b. Further, the sidelink allocation signal 250 may indicate whether the symbol 0 of the different slot 210 will be used for PSSCH reception by the different UE 115 and additionally, indicate whether the symbol 13 of the different slot 210 will be used for PSSCH reception by the different UE 115.

Using the methods as described herein may allow UEs 115 to utilize symbols allocated for AGC 220 or symbols allocated gap 225 for reception of a sidelink communication when the sidelink communication spans multiple slots 210. Using the symbols allocated AGC 220 or the symbols allocated for gap 225 for PSSCH reception may decrease unnecessary overhead and promote the efficient use of sidelink resources.

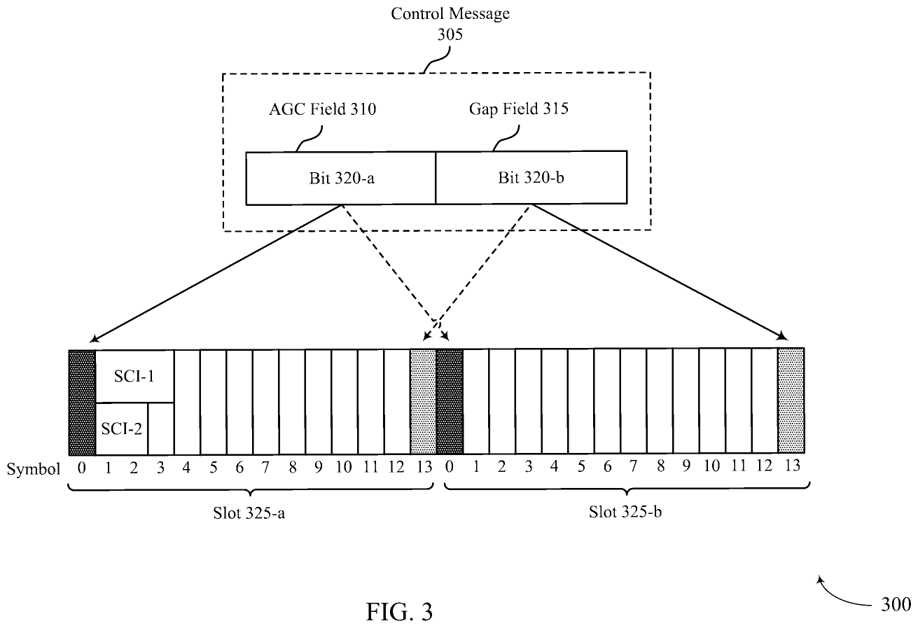

FIG. 3 illustrates an example of a sidelink allocation scheme 300 that supports symbol allocation for multi-slot scheduling in a sidelink system in accordance with one or more aspects of the present disclosure. In some examples, the sidelink allocation scheme 300 may be implemented by aspects of a wireless communications system 100 and a wireless communications system 200. For example, the sidelink allocation scheme 300 may be implemented by UEs 115 as described with reference to FIGS. 1 and 2.

In some examples, a wireless communications system may support sidelink communication. Sidelink communication may be described as communication between two or more UEs. Further, the wireless communications system may support multi-TTI scheduling. Multi-TTI scheduling may allow for aggregation of continuous resources in a time domain which may result in larger resource units. In an example of multi-TTI scheduling, a first UE may be scheduled to transmit a sidelink communication to the one or both of a second UE or a third UE using a slot 325-a and a slot 325-b.

Prior to transmitting the sidelink communication (e.g., prior to slot 325-a), the first UE may transmit a control message 305 (e.g., SCI-1 or SCI-2) to one or both of the second UE or the third UE. The control message 305 may include information associated with the sidelink communication. For example, the control message 305 may include an AGC field 310 and a gap field 315. The AGC field 310 and the gap field 315 may be examples of a bit field that may include one or more bits 320. A logic value of the one or more or more bits 320 in the AGC field 310 may indicate whether an AGC symbol (e.g., a symbol 0) of the one or more scheduled slots 325 (e.g., the slot 325-a and the slot 325-b) may be used for reception of the sidelink communication (e.g., PSSCH). Further, a logic value of the one or more bits 320 in the gap field 315 may indicate whether a gap symbol (e.g., a symbol 13) of the one or more scheduled slots 325 (e.g., the slot 325-a and the slot 325-b) may be used for reception of the sidelink communication (e.g., PSSCH). In the example of FIG. 3, the AGC field 310 may include a single bit 320-a and the gap field 315 may include a single bit 320-b.

In some examples, the first UE may be scheduled to transmit the sidelink communication to the second UE using the slot 325-a and the slot 325-b. When a logic value of the bit 320-a is a first value (e.g., a logic value of 1), the second UE may utilize the AGC symbol (e.g., the symbol 0) of the slot 325-a to receive at least a first portion of the sidelink communication. Conversely, when the logic value of the bit 320-a is a second value (e.g., a logic value of 0), the second UE may utilize the AGC symbol (e.g., the symbol 0) of the slot 325-a for AGC operations (e.g., signal leveling) and may not utilize the AGC symbol to receive the at least first portion of the sidelink communication. The remaining AGC symbols of the scheduled slots 325 (e.g., a symbol 0 of slot 325-b) may be used by the second UE for reception of the sidelink communication.

Additionally or alternatively, when a logic value of the bit 320-b is the first value (e.g., a logic value of 1), the UE 115-b may utilize the gap symbol (e.g., the symbol 13) of the slot 325-b to receive at least a second portion of the sidelink communication. Conversely, when the logic value of the bit 320-b is the second value (e.g., a logic value of 0), the UE 115-b may utilize the gap symbol (e.g., the symbol 13) of the slot 325-b for gap operations (e.g., to transition from reception to transmission) and may not utilize the gap symbol to receive the at least second portion of the sidelink communication. The remaining gap symbols of the scheduled slots 325 (e.g., a symbol 13 of the slot 325-a) may be used by the second UE for reception of the sidelink communication.

In another example, the first UE may be scheduled to transmit sidelink communications to one or both of the second UE or the third UE using the slot 325-a and the slot 325-b. When a logic value of the bit 320-a is a first value (e.g., a logic value of 1), the second UE or the third UE (e.g., depending on which UE is scheduled to receive the sidelink communication in the respective slot) may utilize the AGC symbols (e.g., the symbol 0) of the slot 325-a and the slot 325-b to receive at least a first portion of the sidelink communication. Conversely, when the logic value of the bit 320-a is a second value (e.g., a logic value of 0), the second UE or the third UE may utilize the AGC symbols (e.g., the symbol 0) of the slot 325-a and the slot 325-b for AGC operations (e.g., signal leveling) and may not utilize the AGC symbols to receive the at least first portion of the sidelink communication.

Additionally or alternatively, when a logic value of the bit 320-b is the first value (e.g., a logic value of 1), the second UE or the third UE may utilize the gap symbols (e.g., the symbol 13) of the slot 325-a and 325-b to receive at least a second portion of the sidelink communication. Conversely, when the logic value of the bit 320-b is the second value (e.g., a logic value of 0), the second UE or the third UE may utilize the gap symbols (e.g., the symbol 13) of the slot 325-a and a slot 325-b for gap operations (e.g., to transition from reception to transmission) and may not utilize the gap symbols to receive the at least second portion of the sidelink communication.

If the first UE is scheduled to transmit a first portion of the sidelink communication to the second UE using the slot 325-a and a second portion of the sidelink communication to the third UE using the slot 325-b or if FDRA varies per slot 325, the logic value of the bit 320-a and the bit 320-b may be set to the second value. Alternatively, if the first UE is scheduled to transmit the sidelink communication to one of the second UE or the third UE using the slot 325-a and the slot 325-b (e.g., the receiving UE does not vary per slot 325) or if the FDRA does not vary per slot 325, the logic value of the bit 320-a and the bit 320-b may be set to the first value.

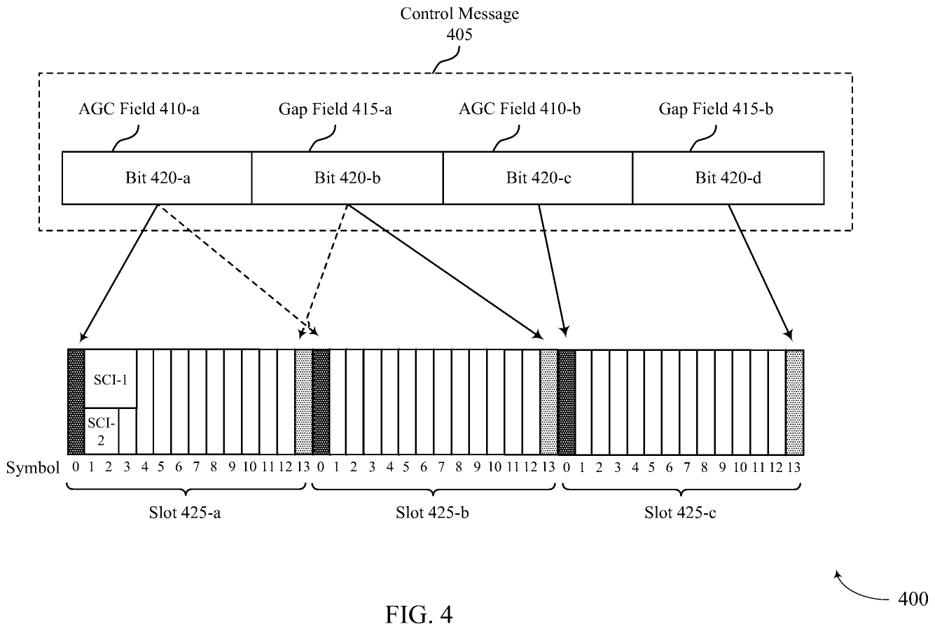

FIG. 4 illustrates an example of a sidelink allocation scheme 400 that supports symbol allocation for multi-slot scheduling in a sidelink system in accordance with one or more aspects of the present disclosure. In some examples, the sidelink allocation scheme 400 may be implemented by aspects of a wireless communications system 100 and a wireless communications system 200. For example, the sidelink allocation scheme 400 may be implemented by UEs 115 as described with reference to FIGS. 1 and 2.

In some examples, a wireless communications system may support sidelink communication. Sidelink communication may be described as communication between two or more UEs. Further, the wireless communications system may support multi-TTI scheduling. Multi-TTI scheduling may allow for aggregation of continuous resources in a time domain which may result in larger resource units. In an example of multi-TTI scheduling, a first UE may be scheduled to transmit a first sidelink communication to a second UE using a slot 425-a and a slot 425-b and transmit a second sidelink communication to a third UE using a slot 425-c.

Prior to transmitting the first sidelink communication and the second sidelink communication (e.g., prior to slot 425-a), the first UE may transmit a control message 405 (e.g., SCI-1 or SCI-2) to both of the second UE and the third UE. The control message 405 may include information associated with the first sidelink communication and the second sidelink communication. For example, the control message may include AGC fields 410 and gap fields 415. The AGC field 410-a and the gap field 415-a may correspond to the second UE and the AGC field 410-b and the gap field 415-b may correspond to the third UE. Further, the AGC fields 410 and the gap fields 415 may be examples of a bit field that include one or more bits 420.

A logic value of the one or more or more bits 420 in the AGC field 410-a may indicate whether an AGC symbol (e.g., the symbol 0) of the one or more scheduled slots 425 (e.g., the slot 425-a and the slot 425-b) may be used by the second UE for reception of the first sidelink communication. Additionally, a logic value of the one or more bits 420 in the AGC field 410-b may indicate whether an AGC symbol (e.g., the symbol 0) of the one or more scheduled slots 425 (e.g., the slot 425-c) may be used by the third UE for reception of the second sidelink communication. Further, a logic value of the one or more or more bits 420 in the gap field 415-a may indicate whether a gap symbol (e.g., the symbol 13) of the one or more scheduled slots 425 (e.g., the slot 425-a and the slot 425-b) may be used by the second UE for reception of the first sidelink communication. Additionally, a logic value of the one or more or more bits 420 in the gap field 415-b may indicate whether a gap symbol (e.g., the symbol 13) of the one or more scheduled slots 425 (e.g., the slot 425-c) may be used by the third UE for reception of the second sidelink communication. In the example of FIG. 4, the AGC field 410-a may include a single bit 420-a, the AGC field 410-b may include a single bit 420-c, the gap field 415-a may include a single bit 420-b, and the gap field 415-b may include a single bit 420-d.

As described herein, the first UE may be scheduled to transmit the first sidelink communication to the second UE using the slot 425-a and the slot 425-b. When a logic value of the bit 420-a is a first value (e.g., a logic value of 1), the second UE may utilize the AGC symbol (e.g., the symbol 0) of the slot 425-a to receive at least a first portion of the first sidelink communication. Conversely, when the logic value of the bit 420-a is a second value (e.g., a logic value of 0), the second UE may utilize the AGC symbol (e.g., the symbol 0) of the slot 425-a for AGC operations (e.g., signal leveling) and may not utilize the AGC symbol to receive the at least first portion of the first sidelink communication. The remaining AGC symbols (e.g., a symbol 0 of slot 425-b) of the scheduled slots 425 may also be used by the second UE for reception of the first sidelink communication.

Additionally or alternatively, when a logic value of the bit 420-b is the first value (e.g., a logic value of 1), the second UE may utilize the gap symbol (e.g., the symbol 13) of the slot 425-b to receive at least a second portion of the first sidelink communication. Conversely, when the logic value of the bit 420-b is the second value (e.g., a logic value of 0), the second UE may utilize the gap symbol (e.g., the symbol 13) of the slot 425-b for gap operations (e.g., to transition from reception to transmission) and may not utilize the gap symbol to receive the at least second portion of the first sidelink communication. The remaining gap symbols (e.g., a symbol 13 of the slot 425-a) of the scheduled slots 325 may also be used by the second UE for reception of the first sidelink communication.

Alternatively, the bits 420 may indicate whether all of the AGC symbols of the scheduled slots 425 and all of the gap symbols of the scheduled slots 425 will be utilized for reception of the sidelink communication. In such examples, when a logic value of the bit 420-a is a first value (e.g., a logic value of 1), the second UE may utilize the AGC symbols (e.g., the symbol 0) of the slot 425-a and the slot 425-b to receive at least a first portion of the first sidelink communication. Conversely, when the logic value of the bit 420-a is a second value (e.g., a logic value of 0), the second UE may utilize the AGC symbols (e.g., the symbol 0) of the slot 425-a and the slot 425-b for AGC operations (e.g., signal leveling) and may not utilize the AGC symbols to receive the at least first portion of the first sidelink communication.

Additionally or alternatively, when a logic value of the bit 420-b is the first value (e.g., a logic value of 1), the second UE may utilize the gap symbols (e.g., the symbol 13) of the slot 425-a and the slot 425-b to receive at least a second portion of the first sidelink communication. Conversely, when the logic value of the bit 420-b is a second value (e.g., a logic value of 0), the second UE may utilize the gap symbols (e.g., the symbol 13) of the slot 425-a and a slot 425-b for gap operations (e.g., to transition from reception to transmission) and may not utilize the gap symbol to receive the at least second portion of the first sidelink communication.

Further, the first UE may be scheduled to transmit the second sidelink communication to the third UE using the slot 425-c. In such case, when a logic value of the bit 420-c is a first value (e.g., a logic value of 1), the third UE may utilize the AGC symbol (e.g., the symbol 0) of the slot 425-c to receive at least a first portion of the second sidelink communication. Conversely, when the logic value of the bit 420-c is a second value (e.g., a logic value of 0), the third UE may utilize the AGC symbol (e.g., the symbol 0) of the slot 425-c for AGC operations (e.g., signal leveling) and may not utilize the AGC symbol to receive the at least first portion of the second sidelink communication.

Additionally or alternatively, when a logic value of the bit 420-d is the first value (e.g., a logic value of 1), the third UE may utilize the gap symbol (e.g., the symbol 13) of the slot 425-c to receive at least a second portion of the second sidelink communication. Conversely, when the logic value of the bit 420-d is the second value (e.g., a logic value of 0), the third UE may utilize the gap symbol (e.g., the symbol 13) of the slot 425-c for gap operations (e.g., to transition from reception to transmission) and may not utilize the gap symbol to receive the at least second portion of the second sidelink communication.

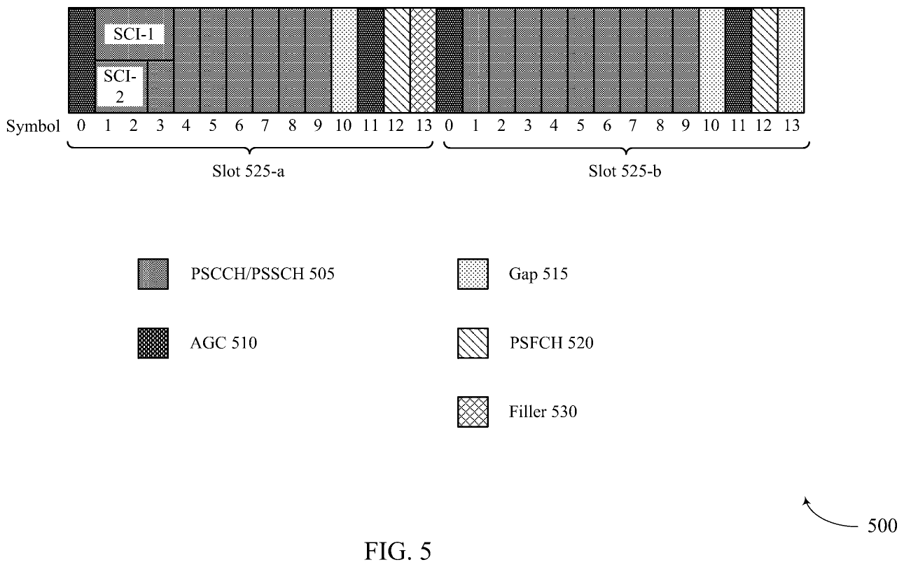

FIG. 5 illustrates an example of a sidelink allocation scheme 500 that supports symbol allocation for multi-slot scheduling in a sidelink system in accordance with one or more aspects of the present disclosure. In some examples, the sidelink allocation scheme 500 may be implemented by aspects of a wireless communications system 100 and a wireless communications system 200. For example, the sidelink allocation scheme 500 may be implemented by UEs 115 as described with reference to FIGS. 1 and 2.

As described with reference to FIG. 2, one or more slots 525 of a set of slots 525 that make up a set of sidelink resources may be utilized for transmission or reception of sidelink feedback. Such slots may include a symbol allocated for PSFCH 520, two or more symbols allocated for gap 515, and two or more symbols allocated for AGC 510. For example, as shown in FIG. 5, for the slot 525-a and the slot 525-b, the symbol 12 may be allocated for PSFCH 520, the symbol 0 and the symbol 11 may be allocated for AGC 510, and the symbol 10 and the symbol 13 may be allocated for gap 515. All the remaining symbols of the slot 525-a and the slot 525-b (e.g., the symbols 1 through 9) may be allocated for PSCCH/PSSCH 505.

In some examples, a UE may be scheduled to transmit a sidelink communication to one or more other UEs using multiple slots 525 that includes at least one slot 525 used for sidelink feedback (e.g., one or both of the slot 525-a and the slot 525-b). For example, a first UE may be scheduled to transmit sidelink communications to one or both of a second UE or a third UE using at least the slot 525-a and the slot 525-b. In such examples, prior to receiving the sidelink communication, the second UE or the third UE may receive a control message (e.g., via SCI-1 or SCI-2) that includes an indication of whether to utilize the gap symbol that occurs after the symbol allocated for PSFCH 520 (e.g., the symbol 13 of the one or more slots 525) for reception of the sidelink communication (PSSCH) and a first symbol allocated for AGC 510 (e.g., the symbol 0) for reception of the sidelink communication. The second symbol allocated for AGC 510 (e.g., the symbol 11 of the one or more slots 525) may be utilized for power control operations and the gap symbol that occurs prior to PSFCH 520 (e.g., the symbol 10 of the one or more slots 525) may be used for gap operations. In some examples, the PSFCH transmission may use a CP extension to make sure the gap is less than 16/25 μs.

In some examples, the indication may be provided to the second UE or the third UE in a similar method as described in FIGS. 3 and 4. For example, the indication may include one or more gap fields. As one example, a gap field of the one or more gap fields may indicate whether the gap symbol after the symbol allocated for PSFCH 520 of the last scheduled slot 525 (e.g., the symbol 13 of the slot 525-b) will be used for reception of the sidelink communication or may indicate whether each gap symbol after the symbol allocated for PSFCH 520 of each scheduled slot (e.g., the symbol 13 of the slot 525-a and the slot 525-b) will be used for reception of the sidelink communication (e.g., similar to what is described in FIG. 3 with respect to gap field 315). A similar field may be present for the first AGC symbol.

In another example, the indication may include multiple gap fields where each gap field is associated with a UE receiving the sidelink communication and a respective gap field of the one or more gap fields may indicate whether the gap symbol (e.g., the symbol 13 of the last scheduled slot or the symbol 13 of each scheduled slot) will be used for reception of the sidelink communication by a respective UE (e.g., similar to what is described in FIG. 4 with respect to gap fields 415). Similar fields may be present for the first AGC symbol.

In another example, the gap symbol after the symbol allocated for PSFCH 520 may be allocated for filler 530 (e.g., reference signaling or any other filler signaling). The filler 530 may be added to all gap symbols after the symbol allocated for PSFCH 520 for slots 525 that are not the last scheduled slot 525 (e.g., the slot 525-a) such that the channel is maintained. As an example, the second UE or the third UE may utilize the gap symbol after the symbol allocated for PSFCH 520 (e.g., the symbol 13) of the slot 525-a for reception of filler signaling as opposed to reception of the sidelink communication (e.g., PSSCH) or for gap 515.

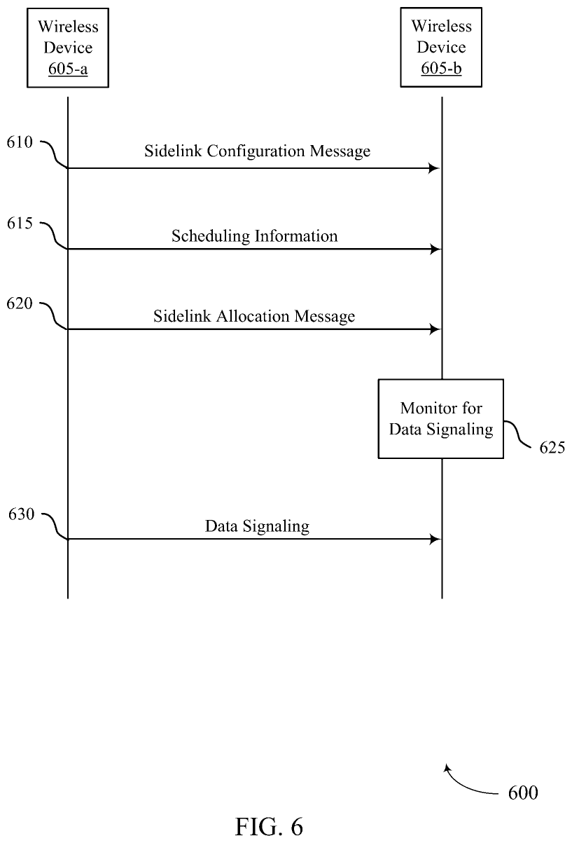

FIG. 6 illustrates an example of a process flow 600 that supports symbol allocation for multi-slot scheduling in a sidelink system in accordance with one or more aspects of the present disclosure. In some examples, the process flow 600 may implement aspects of a wireless communications system 100 and a wireless communications system 200. For example, the process flow 600 may implement, or be implemented by, a wireless device 605-a and a wireless device 605-b which may be examples of UEs 115 or network entities 105 as described with reference to FIGS. 1 and 2. Alternative examples of the following may be implemented, where some steps are performed in a different order than described or are not performed at all. In some cases, steps may include additional features not mentioned below, or furth steps may be added.

At 610, the wireless device 605-a may transmit a sidelink configuration message (or a first control signal) to the wireless device 605-b. The sidelink configuration message may include an indication of a set of sidelink resources within a subcarrier. The set of sidelink resources may include a set of slots that include a first set of symbols allocated for power control signaling (e.g., AGC symbols) and a second set of symbols allocated as gap symbols. Additionally or alternatively, a subset of the set of slots may include a third set of symbols allocated for sidelink feedback.

At 615, the wireless device 605-a may transmit scheduling information (or control information) to the wireless device 605-b. The scheduling information may be included in DCI or SCI. Further, the scheduling information may schedule the wireless device 605-a to receive a first data signal using a first slot and a second slot of the set of slots. The first slot may be before the second slot in time and the first slot may be adjacent to the second slot. In some examples, the first slot and the second slot may be associated with a same set of frequency resources (e.g., same FDRA) or different sets of frequency resources (e.g., different FDRA). Additionally or alternatively, the scheduling information may schedule a different wireless device 605 (e.g., a wireless device different from the wireless device 605-a) to receive a second data signal using a third slot that is after the second slot in time and adjacent to the second slot.

At 620, the wireless device 605-a may transmit a sidelink allocation message (or a second control signal) to the wireless device 605-b. The sidelink allocation message may be included in SCI (e.g., SCI-1 or SCI-2). Further, the sidelink allocation message may include an indication of whether to receive a first data signal using one or both of the first set of symbols or the second set of symbols. In some examples, the sidelink allocation message may include a first bit indicating whether to receive at least a first portion of the first data signal using the first set of symbols and a second bit indicating whether to receive at least a second portion of the first data signal using the second set of symbols.

In some examples, the first slot and the second slot may be associated with different sets of frequency resources. In such examples, the indication may include a first bit indicating whether to receive at least a first portion of the first data signal using a subset of the set of symbols of the first slot, a second bit indicating whether to receive at least a second portion of the first data signal using a subset of the second set of symbols of the first slot, a third bit indicating whether to receive at least first a portion of the second data signal over a subset of the first set of symbols of the second slot, and a fourth bit indicating whether to receive at least a second portion of the second data signal over a subset of the second set of symbols of the second slot.

Additionally or alternatively, the sidelink allocation message may include an indication of whether to receive the second data signal using one or both of the first set of symbols or the second set of symbols of the third slot. In such examples, the sidelink allocation message may include a first bit indicating whether to receive at least a first portion of the first data signal using the first set of symbols, a second bit indicating whether to receive at least a first portion of the first data signal using the second set of symbols, a third bit indicating whether to receive at least a first portion of the second data signal over the first set of symbols, and a fourth bit indicating whether to receive at least a second portion of the second data signal over the second set of symbols.

At 625, the wireless device 605-b may receive the first data signal from the wireless device 605-a in accordance to the sidelink allocation message. In some examples, the wireless device 605-b may receive a first portion of the first data signal using a subset of the first set of symbols corresponding to the first slot and a subset of the second set of symbols corresponding to the second slot. In another example, the wireless device 605-a may receive a first portion of the first data signal using a subset of the first set of symbols corresponding to the first slot and the second slot and a subset of the second set of symbols corresponding to the first slot and the second slot. In some examples, one or both of the first slot or the second slot may include symbols allocated for sidelink feedback. In such examples, the subset of the second set of symbols corresponding to one or both of the first slot or the second slot may instead be allocated for filler signaling and the subset of the first set of symbols corresponding to one or both of the first slot or the second slot may be allocated for power control signaling.

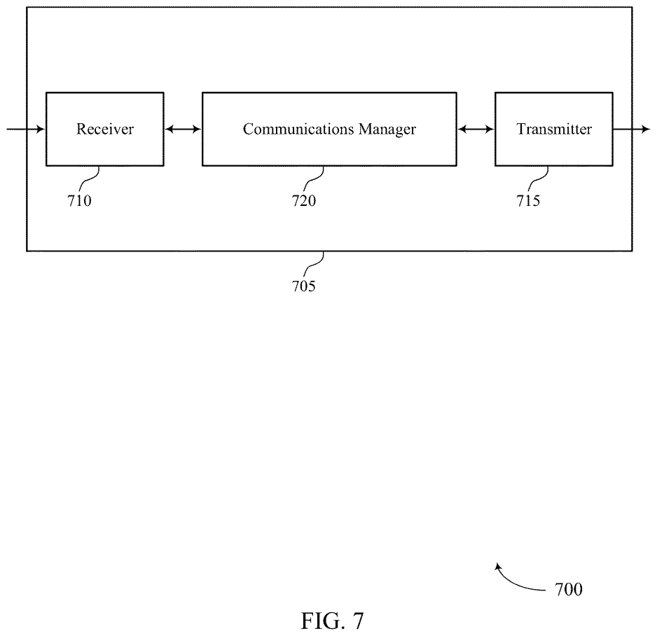

FIG. 7 illustrates a block diagram 700 of a device 705 that supports symbol allocation for multi-slot scheduling in a sidelink system in accordance with one or more aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to symbol allocation for multi-slot scheduling in a sidelink system). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to symbol allocation for multi-slot scheduling in a sidelink system). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of symbol allocation for multi-slot scheduling in a sidelink system as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a first UE in accordance with examples as disclosed herein. For example, the communications manager 720 may be configured as or otherwise support a means for receiving a first control signal that indicates a set of sidelink resources including a set of multiple slots within a subcarrier, where the set of multiple slots includes a first set of symbols allocated for power control signaling and a second set of symbols allocated as gap symbols. The communications manager 720 may be configured as or otherwise support a means for receiving, based on receiving the first control signal, a second control signal including an indication of whether to receive a first data signal using one or both of the first set of symbols or the second set of symbols. The communications manager 720 may be configured as or otherwise support a means for receiving the first data signal in accordance with the indication.

Additionally, or alternatively, the communications manager 720 may support wireless communication at a first UE in accordance with examples as disclosed herein. For example, the communications manager 720 may be configured as or otherwise support a means for receiving a first control signal that indicates a set of sidelink resources including a set of multiple slots within a subcarrier, where the set of multiple slots includes a first set of symbols allocated for power control signaling and a second set of symbols allocated as gap symbols. The communications manager 720 may be configured as or otherwise support a means for transmitting, based on receiving the first control signal, a second control signal including an indication of whether a second UE is to receive a first data signal using one or both of the first set of symbols or the second set of symbols. The communications manager 720 may be configured as or otherwise support a means for transmitting the first data signal in accordance with the indication.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for more efficient utilization of communication resources.

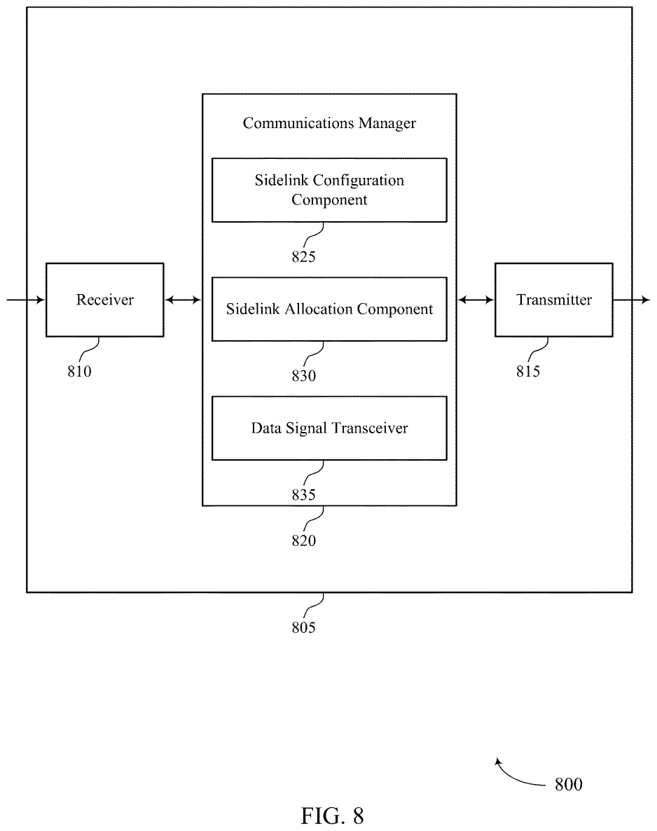

FIG. 8 illustrates a block diagram 800 of a device 805 that supports symbol allocation for multi-slot scheduling in a sidelink system in accordance with one or more aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to symbol allocation for multi-slot scheduling in a sidelink system). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to symbol allocation for multi-slot scheduling in a sidelink system). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of symbol allocation for multi-slot scheduling in a sidelink system as described herein. For example, the communications manager 820 may include an sidelink configuration component 825, an sidelink allocation component 830, a data signal transceiver 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a first UE in accordance with examples as disclosed herein. The sidelink configuration component 825 may be configured as or otherwise support a means for receiving a first control signal that indicates a set of sidelink resources including a set of multiple slots within a subcarrier, where the set of multiple slots includes a first set of symbols allocated for power control signaling and a second set of symbols allocated as gap symbols. The sidelink allocation component 830 may be configured as or otherwise support a means for receiving, based on receiving the first control signal, a second control signal including an indication of whether to receive a first data signal using one or both of the first set of symbols or the second set of symbols. The data signal transceiver 835 may be configured as or otherwise support a means for receiving the first data signal in accordance with the indication.

Additionally, or alternatively, the communications manager 820 may support wireless communication at a first UE in accordance with examples as disclosed herein. The sidelink configuration component 825 may be configured as or otherwise support a means for receiving a first control signal that indicates a set of sidelink resources including a set of multiple slots within a subcarrier, where the set of multiple slots includes a first set of symbols allocated for power control signaling and a second set of symbols allocated as gap symbols. The sidelink allocation component 830 may be configured as or otherwise support a means for transmitting, based on receiving the first control signal, a second control signal including an indication of whether a second UE is to receive a first data signal using one or both of the first set of symbols or the second set of symbols. The data signal transceiver 835 may be configured as or otherwise support a means for transmitting the first data signal in accordance with the indication.

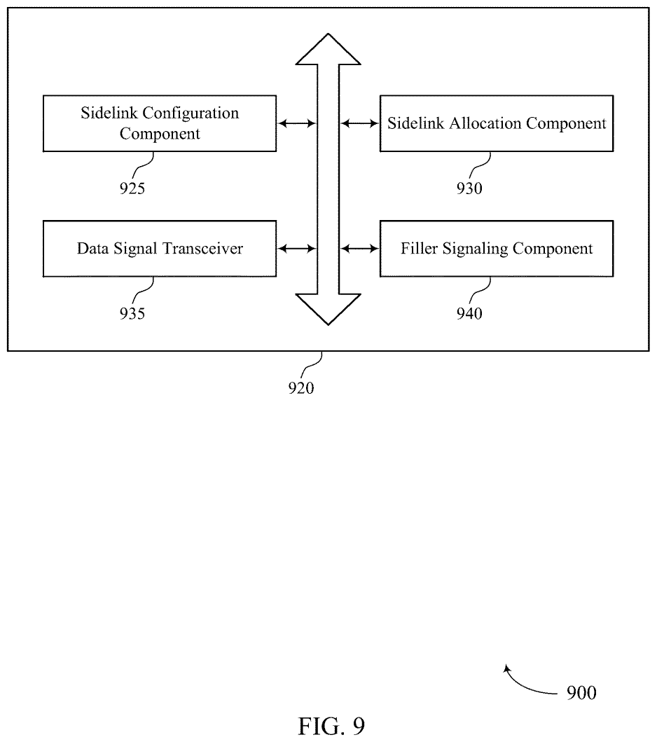

FIG. 9 illustrates a block diagram 900 of a communications manager 920 that supports symbol allocation for multi-slot scheduling in a sidelink system in accordance with one or more aspects of the present disclosure. The communications manager 920 may be an example of aspects of a communications manager 720, a communications manager 820, or both, as described herein. The communications manager 920, or various components thereof, may be an example of means for performing various aspects of symbol allocation for multi-slot scheduling in a sidelink system as described herein. For example, the communications manager 920 may include an sidelink configuration component 925, an sidelink allocation component 930, a data signal transceiver 935, a filler signaling component 940, or any combination thereof. Each of these components may communicate, directly or indirectly, with one another (e.g., via one or more buses).

The communications manager 920 may support wireless communication at a first UE in accordance with examples as disclosed herein. The sidelink configuration component 925 may be configured as or otherwise support a means for receiving a first control signal that indicates a set of sidelink resources including a set of multiple slots within a subcarrier, where the set of multiple slots includes a first set of symbols allocated for power control signaling and a second set of symbols allocated as gap symbols. The sidelink allocation component 930 may be configured as or otherwise support a means for receiving, based on receiving the first control signal, a second control signal including an indication of whether to receive a first data signal using one or both of the first set of symbols or the second set of symbols. The data signal transceiver 935 may be configured as or otherwise support a means for receiving the first data signal in accordance with the indication.

In some examples, to support receiving the second control signal, the sidelink allocation component 930 may be configured as or otherwise support a means for receiving control information scheduling the first UE to receive the first data signal using a first slot of the set of multiple slots and a second slot of the set of multiple slots, where the first slot is before the second slot in time.

In some examples, to support receiving the first data signal, the data signal transceiver 935 may be configured as or otherwise support a means for receiving a first portion of the first data signal using a subset of the first set of symbols corresponding to the first slot in accordance with the indication signaling to receive the first data signal using the first set of symbols.

In some examples, to support receiving the first data signal, the data signal transceiver 935 may be configured as or otherwise support a means for receiving a second portion of the first data signal using a subset of the first set of symbols corresponding to the second slot in accordance with the indication signaling to receive the first data signal using the first set of symbols.

In some examples, to support receiving the first data signal, the data signal transceiver 935 may be configured as or otherwise support a means for receiving a first portion of the first data signal using a subset of the second set of symbols corresponding to the second slot in accordance with the indication signaling to receive the first data signal using the second set of symbols.

In some examples, to support receiving the first data signal, the data signal transceiver 935 may be configured as or otherwise support a means for receiving a second portion of the first data signal using a subset of the second set of symbols corresponding to the first slot in accordance with the indication signaling to receive the first data signal using the second set of symbols.

In some examples, the first slot is associated with a first frequency domain resource allocation and the second slot is associated with a second frequency domain resource allocation different from the first frequency domain resource allocation. In some examples, the second control signal includes a first bit indicating whether to receive a first portion of the first data signal using a subset of the first set of symbols corresponding to the first slot, a second bit indicating whether to receive a second portion of the first data signal using a subset of the second set of symbols corresponding to the first slot, a third bit indicating whether to receive a third portion of the first data signal using a subset of the first set of symbols corresponding to the second slot, and a fourth bit indicating whether to receive a fourth portion of the first data signal using a subset of the second set of symbols corresponding to the second slot.

In some examples, the second control signal includes a first bit indicating whether to receive a first a portion of the first data signal using the first set of symbols and a second bit indicating whether to receive a second portion of the first data signal using the second set of symbols.

In some examples, to support receiving the second control signal, the sidelink allocation component 930 may be configured as or otherwise support a means for receiving first control information scheduling the first UE to receive the first data signal using one or more first slots of the set of multiple slots and second control information scheduling a second UE to receive a second data signal using one or more second slots of the set of multiple slots.

In some examples, the second control signal includes an indication of whether to receive the second data signal using one or both of the first set of symbols or the second set of symbols.

In some examples, the second control signal includes a first bit indicating whether to receive a first portion of the first data signal using a first subset of the first set of symbols, a second bit indicating whether to receive a second portion of the first data signal using a first subset of the second set of symbols, a third bit indicating whether to receive a first portion of the second data signal using a second subset of the first set of symbols, and a fourth bit indicating whether to receive a second portion of the second data signal using a second subset of the second set of symbols.

In some examples, to support receiving the first data signal, the data signal transceiver 935 may be configured as or otherwise support a means for receiving the first data signal using a subset of the second set of symbols corresponding to a slot of the subset of slots in accordance with the indication signaling to receive the first data signal using the second set of symbols.

In some examples, a subset of the set of multiple slots includes a third set of symbols allocated for sidelink feedback, and the filler signaling component 940 may be configured as or otherwise support a means for receiving filler signaling using a subset of the second set of symbols corresponding to a slot of the subset of slots. In some examples, the second control signal includes type 1 SCI or type 2 SCI.

Additionally, or alternatively, the communications manager 920 may support wireless communication at a first UE in accordance with examples as disclosed herein. In some examples, the sidelink configuration component 925 may be configured as or otherwise support a means for receiving a first control signal that indicates a set of sidelink resources including a set of multiple slots within a subcarrier, where the set of multiple slots includes a first set of symbols allocated for power control signaling and a second set of symbols allocated as gap symbols. In some examples, the sidelink allocation component 930 may be configured as or otherwise support a means for transmitting, based on receiving the first control signal, a second control signal including an indication of whether a second UE is to receive a first data signal using one or both of the first set of symbols or the second set of symbols. In some examples, the data signal transceiver 935 may be configured as or otherwise support a means for transmitting the first data signal in accordance with the indication.

In some examples, to support transmitting the second control signal, the sidelink allocation component 930 may be configured as or otherwise support a means for transmitting control information scheduling the second UE to receive the first data signal using a first slot of the set of multiple slots and a second slot of the set of multiple slots, where the first slot is before the second slot in time.

In some examples, to support transmitting the first data signal, the data signal transceiver 935 may be configured as or otherwise support a means for transmitting a first portion of the first data signal using a subset of the first set of symbols corresponding to the first slot in accordance with the indication signaling the second UE to receive the first data signal using the first set of symbols.

In some examples, to support transmitting the first data signal, the data signal transceiver 935 may be configured as or otherwise support a means for transmitting a second portion of the first data signal using a subset of the first set of symbols corresponding to the second slot in accordance with the indication signaling the second UE to receive the first data signal using the first set of symbols.

In some examples, to support transmitting the first data signal, the data signal transceiver 935 may be configured as or otherwise support a means for transmitting a first portion of the first data signal using subset of the second set of symbols corresponding to the second slot in accordance with the indication signaling the second UE to receive the first data signal using the second set of symbols.

In some examples, to support transmitting the first data signal, the data signal transceiver 935 may be configured as or otherwise support a means for transmitting a second portion of the first data signal using a subset of the second set of symbols corresponding to the first slot in accordance with the indication signaling the second UE to receive the first data signal using the second set of symbols.

In some examples, the first slot is associated with a first frequency domain resource allocation and the second slot is associated with a second frequency domain resource allocation different from the first frequency domain resource allocation. In some examples, the second control signal includes a first bit indicating whether the second UE is to receive a first portion of the first data signal using a subset of the first set of symbols corresponding to the first slot, a second bit indicating whether the second UE is to receive a second portion of the first data signal using a subset of the second set of symbols corresponding to the first slot, a third bit indicating whether the second UE is to receive a third portion of the first data signal using a subset of the first set of symbols corresponding to second slot, and a fourth bit indicating whether the second UE is to receive a fourth portion of the first data signal using a second subset of the second set of symbols corresponding to the second slot.

In some examples, the second control signal includes a first bit indicating whether the second UE is to receive a first portion the first data signal using the first set of symbols and a second bit indicating whether the second UE is to receive a second portion of the first data signal using the second set of symbols.

In some examples, to support transmitting the second control signal, the sidelink allocation component 930 may be configured as or otherwise support a means for transmitting first control information scheduling the second UE to receive the first data signal using one or more first slots of the set of multiple slots and second control information scheduling a third UE to receive second data signal using one or more second slots of the set of multiple slots.

In some examples, the second control signal includes an indication of whether the third UE is to receive the second data signal using one or both of the first set of symbols or the second set of symbols.

In some examples, the second control signal includes a first bit indicating whether the second UE is to receive a first portion of the first data signal using a first subset of the first set of symbols, a second bit indicating whether the second UE is to receive a second portion of the first data signal using a first subset of the second set of symbols, a third bit whether the third UE is to receive a first portion of the second data signal using a second subset of the first set of symbols, and a fourth bit indicating whether the third UE is to receive a second portion of the second data signal using a second subset of the second set of symbols.

In some examples, to support transmitting the first data signal, the data signal transceiver 935 may be configured as or otherwise support a means for transmitting the first data signal using a subset of the second set of symbols corresponding to a slot of the subset of slots in accordance with the indication signaling the second UE receive the first data signal using the second set of symbols.

In some examples, a subset of the set of multiple slots includes a third set of symbols allocated for sidelink feedback, and the filler signaling component 940 may be configured as or otherwise support a means for transmitting filler signaling using a subset of the second set of symbols corresponding to a slot of the subset of slots.

In some examples, the second control signal includes type 1 SCI or type 2 SCI.

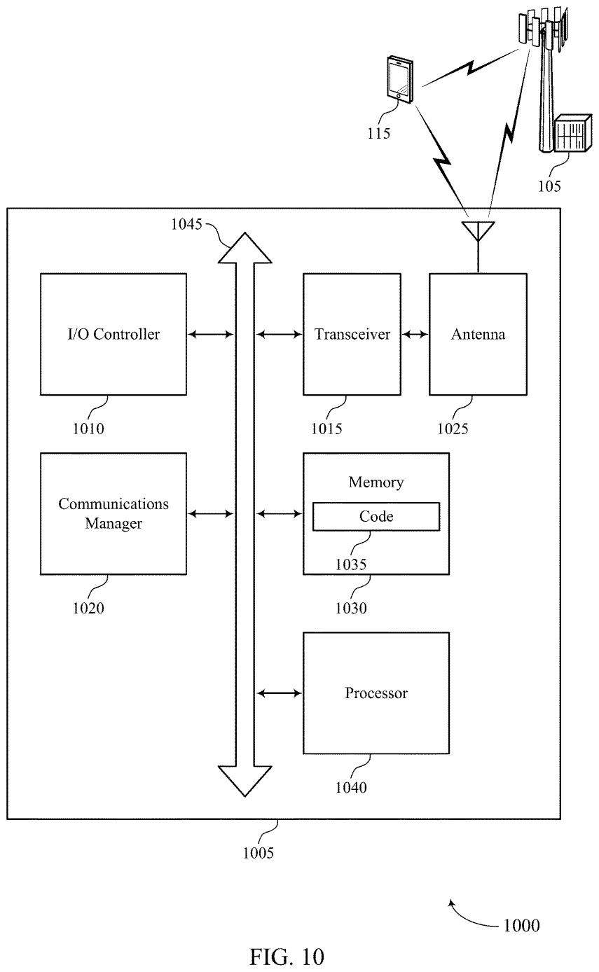

FIG. 10 illustrates a diagram of a system 1000 including a device 1005 that supports symbol allocation for multi-slot scheduling in a sidelink system in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting symbol allocation for multi-slot scheduling in a sidelink system). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communication at a first UE in accordance with examples as disclosed herein. For example, the communications manager 1020 may be configured as or otherwise support a means for receiving a first control signal that indicates a set of sidelink resources including a set of multiple slots within a subcarrier, where the set of multiple slots includes a first set of symbols allocated for power control signaling and a second set of symbols allocated as gap symbols. The communications manager 1020 may be configured as or otherwise support a means for receiving, based on receiving the first control signal, a second control signal including an indication of whether to receive a first data signal using one or both of the first set of symbols or the second set of symbols. The communications manager 1020 may be configured as or otherwise support a means for receiving the first data signal in accordance with the indication.

Additionally, or alternatively, the communications manager 1020 may support wireless communication at a first UE in accordance with examples as disclosed herein. For example, the communications manager 1020 may be configured as or otherwise support a means for receiving a first control signal that indicates a set of sidelink resources including a set of multiple slots within a subcarrier, where the set of multiple slots includes a first set of symbols allocated for power control signaling and a second set of symbols allocated as gap symbols. The communications manager 1020 may be configured as or otherwise support a means for transmitting, based on receiving the first control signal, a second control signal including an indication of whether a second UE is to receive a first data signal using one or both of the first set of symbols or the second set of symbols. The communications manager 1020 may be configured as or otherwise support a means for transmitting the first data signal in accordance with the indication.

By including or configuring the communications manager 1020 in accordance with examples as described herein, the device 1005 may support techniques for more efficient utilization of communication resources.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of symbol allocation for multi-slot scheduling in a sidelink system as described herein, or the processor 1040 and the memory 1030 may be otherwise configured to perform or support such operations.

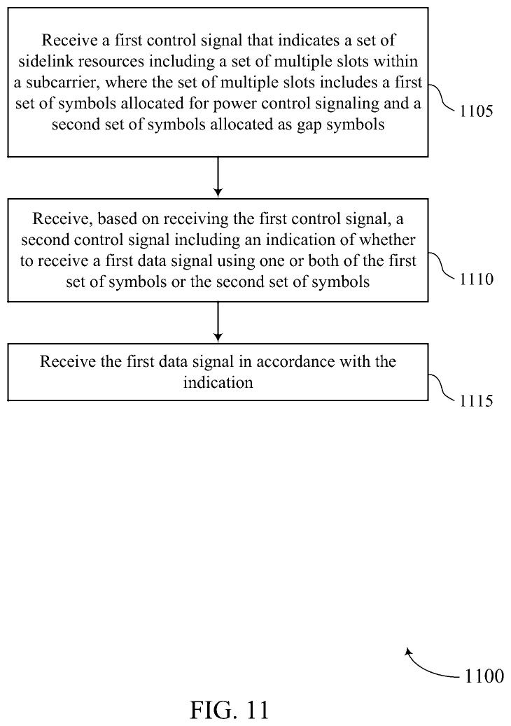

FIG. 11 illustrates a flowchart showing a method 1100 that supports symbol allocation for multi-slot scheduling in a sidelink system in accordance with one or more aspects of the present disclosure. The operations of the method 1100 may be implemented by a UE or its components as described herein. For example, the operations of the method 1100 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1105, the method may include receiving a first control signal that indicates a set of sidelink resources including a set of multiple slots within a subcarrier, where the set of multiple slots includes a first set of symbols allocated for power control signaling and a second set of symbols allocated as gap symbols. The operations of 1105 may be performed in accordance with examples as disclosed herein. In some examples, aspects of the operations of 1105 may be performed by an sidelink configuration component 925 as described with reference to FIG. 9.

At 1110, the method may include receiving, based on receiving the first control signal, a second control signal including an indication of whether to receive a first data signal using one or both of the first set of symbols or the second set of symbols. The operations of 1110 may be performed in accordance with examples as disclosed herein. In some examples, aspects of the operations of 1110 may be performed by an sidelink allocation component 930 as described with reference to FIG. 9.

At 1115, the method may include receiving the first data signal in accordance with the indication. The operations of 1115 may be performed in accordance with examples as disclosed herein. In some examples, aspects of the operations of 1115 may be performed by a data signal transceiver 935 as described with reference to FIG. 9.

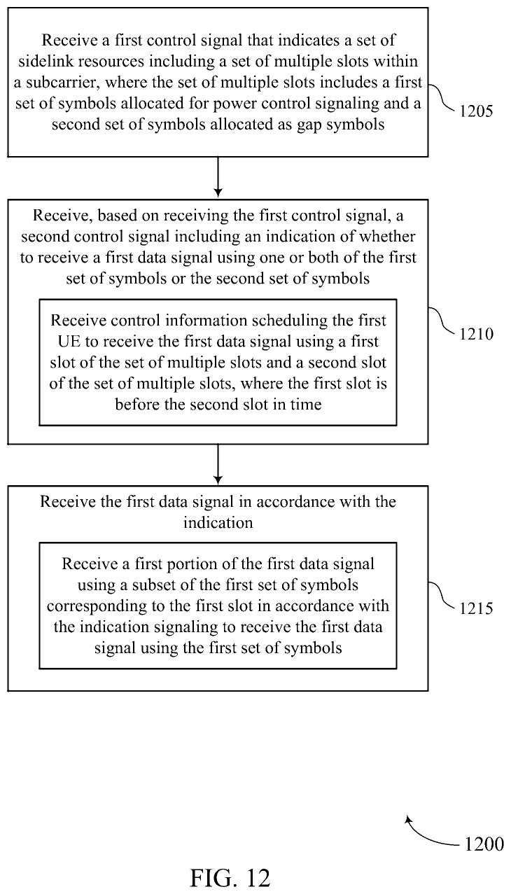

FIG. 12 illustrates a flowchart showing a method 1200 that supports symbol allocation for multi-slot scheduling in a sidelink system in accordance with one or more aspects of the present disclosure. The operations of the method 1200 may be implemented by a UE or its components as described herein. For example, the operations of the method 1200 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1205, the method may include receiving a first control signal that indicates a set of sidelink resources including a set of multiple slots within a subcarrier, where the set of multiple slots includes a first set of symbols allocated for power control signaling and a second set of symbols allocated as gap symbols. The operations of 1205 may be performed in accordance with examples as disclosed herein. In some examples, aspects of the operations of 1205 may be performed by an sidelink configuration component 925 as described with reference to FIG. 9.

At 1210, the method may include receiving, based on receiving the first control signal, a second control signal including an indication of whether to receive a first data signal using one or both of the first set of symbols or the second set of symbols. In some examples, receiving the control signal may include receiving control information scheduling the first UE to receive the first data signal using a first slot of the set of multiple slots and a second slot of the set of multiple slots, where the first slot is before the second slot in time. The operations of 1210 may be performed in accordance with examples as disclosed herein. In some examples, aspects of the operations of 1210 may be performed by an sidelink allocation component 930 as described with reference to FIG. 9.

At 1215, the method may include receiving the first data signal in accordance with the indication. In some examples, receiving the first data signal may include receiving a first portion of the first data signal using a subset of the first set of symbols corresponding to the first slot in accordance with the indication signaling to receive the first data signal using the first set of symbols. The operations of 1215 may be performed in accordance with examples as disclosed herein. In some examples, aspects of the operations of 1215 may be performed by a data signal transceiver 935 as described with reference to FIG. 9.

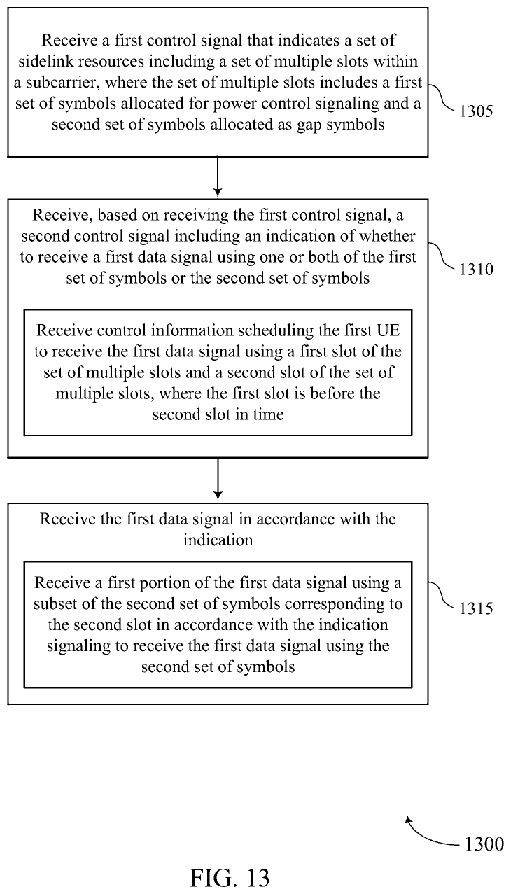

FIG. 13 illustrates a flowchart showing a method 1300 that supports symbol allocation for multi-slot scheduling in a sidelink system in accordance with one or more aspects of the present disclosure. The operations of the method 1300 may be implemented by a UE or its components as described herein. For example, the operations of the method 1300 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1305, the method may include receiving a first control signal that indicates a set of sidelink resources including a set of multiple slots within a subcarrier, where the set of multiple slots includes a first set of symbols allocated for power control signaling and a second set of symbols allocated as gap symbols. The operations of 1305 may be performed in accordance with examples as disclosed herein. In some examples, aspects of the operations of 1305 may be performed by an sidelink configuration component 925 as described with reference to FIG. 9.

At 1310, the method may include receiving, based on receiving the first control signal, a second control signal including an indication of whether to receive a first data signal using one or both of the first set of symbols or the second set of symbols. In some examples, receiving the first control signal includes receiving control information scheduling the first UE to receive the first data signal using a first slot of the set of multiple slots and a second slot of the set of multiple slots, where the first slot is before the second slot in time. The operations of 1310 may be performed in accordance with examples as disclosed herein. In some examples, aspects of the operations of 1310 may be performed by an sidelink allocation component 930 as described with reference to FIG. 9.

At 1315, the method may include receiving the first data signal in accordance with the indication. In some examples, receiving the first data signal includes receiving a first portion of the first data signal using a subset of the second set of symbols corresponding to the second slot in accordance with the indication signaling to receive the first data signal using the second set of symbols. The operations of 1315 may be performed in accordance with examples as disclosed herein. In some examples, aspects of the operations of 1315 may be performed by a data signal transceiver 935 as described with reference to FIG. 9.

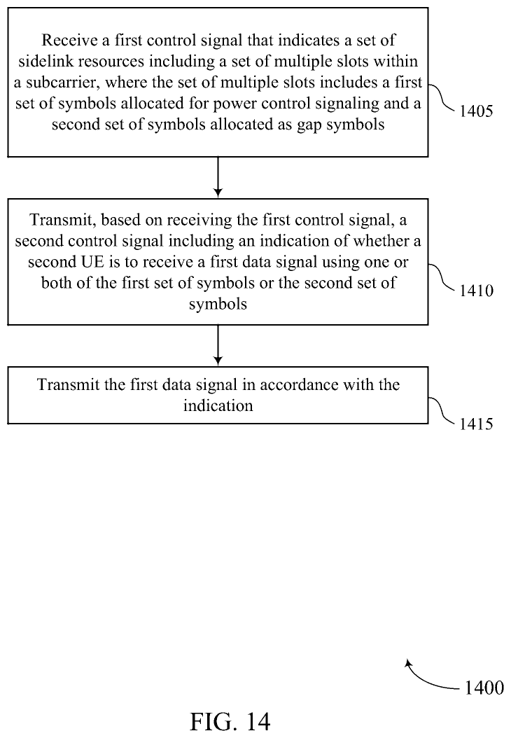

FIG. 14 illustrates a flowchart showing a method 1400 that supports symbol allocation for multi-slot scheduling in a sidelink system in accordance with one or more aspects of the present disclosure. The operations of the method 1400 may be implemented by a UE or its components as described herein. For example, the operations of the method 1400 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1405, the method may include receiving a first control signal that indicates a set of sidelink resources including a set of multiple slots within a subcarrier, where the set of multiple slots includes a first set of symbols allocated for power control signaling and a second set of symbols allocated as gap symbols. The operations of 1405 may be performed in accordance with examples as disclosed herein. In some examples, aspects of the operations of 1405 may be performed by an sidelink configuration component 925 as described with reference to FIG. 9.

At 1410, the method may include transmitting, based on receiving the first control signal, a second control signal including an indication of whether a second UE is to receive a first data signal using one or both of the first set of symbols or the second set of symbols. The operations of 1410 may be performed in accordance with examples as disclosed herein. In some examples, aspects of the operations of 1410 may be performed by an sidelink allocation component 930 as described with reference to FIG. 9.

At 1415, the method may include transmitting the first data signal in accordance with the indication. The operations of 1415 may be performed in accordance with examples as disclosed herein. In some examples, aspects of the operations of 1415 may be performed by a data signal transceiver 935 as described with reference to FIG. 9.

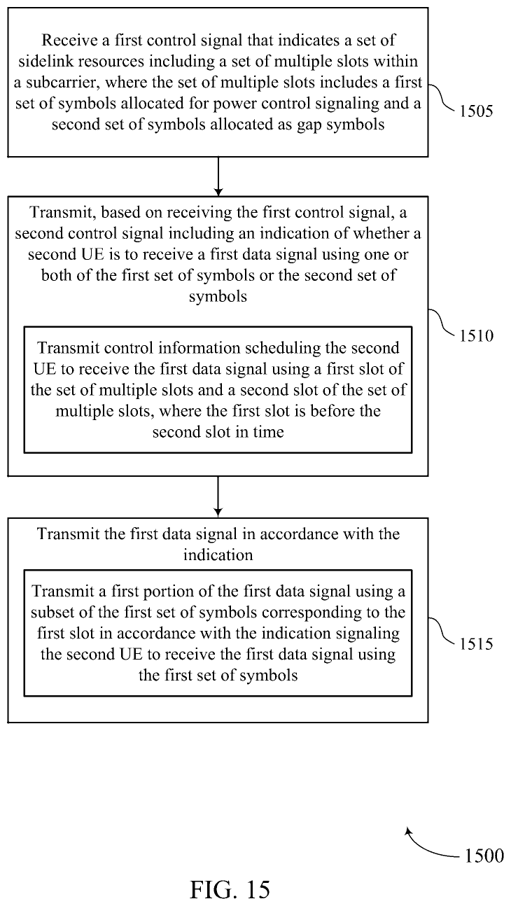

FIG. 15 illustrates a flowchart showing a method 1500 that supports symbol allocation for multi-slot scheduling in a sidelink system in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving a first control signal that indicates a set of sidelink resources including a set of multiple slots within a subcarrier, where the set of multiple slots includes a first set of symbols allocated for power control signaling and a second set of symbols allocated as gap symbols. The operations of 1505 may be performed in accordance with examples as disclosed herein. In some examples, aspects of the operations of 1505 may be performed by an sidelink configuration component 925 as described with reference to FIG. 9.

At 1510, the method may include transmitting, based on receiving the first control signal, a second control signal including an indication of whether a second UE is to receive a first data signal using one or both of the first set of symbols or the second set of symbols. In some examples, transmitting the first control signal includes transmitting control information scheduling the second UE to receive the first data signal using a first slot of the set of multiple slots and a second slot of the set of multiple slots, where the first slot is before the second slot in time. The operations of 1510 may be performed in accordance with examples as disclosed herein. In some examples, aspects of the operations of 1510 may be performed by an sidelink allocation component 930 as described with reference to FIG. 9.

At 1515, the method may include transmitting the first data signal in accordance with the indication. In some examples, transmitting the first data signal includes transmitting a first portion of the first data signal using a subset of the first set of symbols corresponding to the first slot in accordance with the indication signaling the second UE to receive the first data signal using the first set of symbols. The operations of 1515 may be performed in accordance with examples as disclosed herein. In some examples, aspects of the operations of 1515 may be performed by a data signal transceiver 935 as described with reference to FIG. 9.

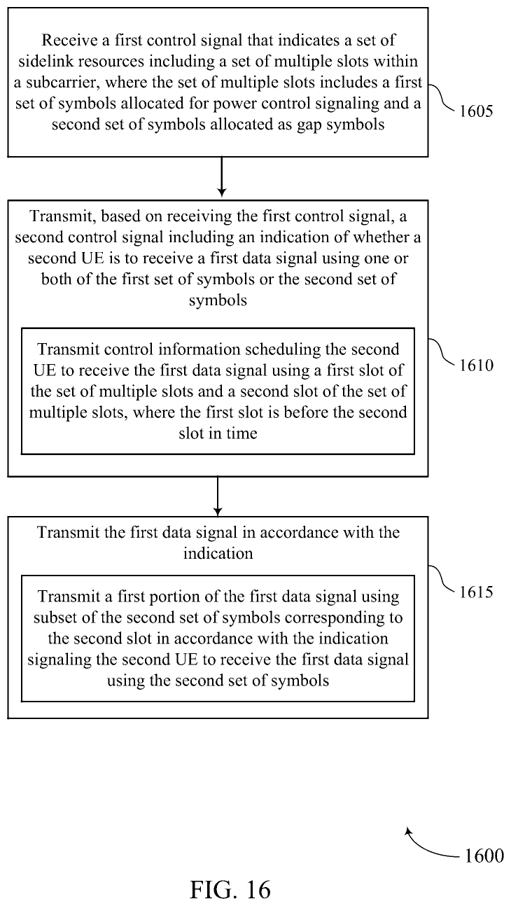

FIG. 16 illustrates a flowchart showing a method 1600 that supports symbol allocation for multi-slot scheduling in a sidelink system in accordance with one or more aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include receiving a first control signal that indicates a set of sidelink resources including a set of multiple slots within a subcarrier, where the set of multiple slots includes a first set of symbols allocated for power control signaling and a second set of symbols allocated as gap symbols. The operations of 1605 may be performed in accordance with examples as disclosed herein. In some examples, aspects of the operations of 1605 may be performed by an sidelink configuration component 925 as described with reference to FIG. 9.

At 1610, the method may include transmitting, based on receiving the first control signal, a second control signal including an indication of whether a second UE is to receive a first data signal using one or both of the first set of symbols or the second set of symbols. In some examples, transmitting the first control signal includes transmitting control information scheduling the second UE to receive the first data signal using a first slot of the set of multiple slots and a second slot of the set of multiple slots, where the first slot is before the second slot in time. The operations of 1610 may be performed in accordance with examples as disclosed herein. In some examples, aspects of the operations of 1610 may be performed by an sidelink allocation component 930 as described with reference to FIG. 9.

At 1615, the method may include transmitting the first data signal in accordance with the indication. In some examples, transmitting the first data signals includes transmitting a first portion of the first data signal using subset of the second set of symbols corresponding to the second slot in accordance with the indication signaling the second UE to receive the first data signal using the second set of symbols. The operations of 1615 may be performed in accordance with examples as disclosed herein. In some examples, aspects of the operations of 1615 may be performed by a data signal transceiver 935 as described with reference to FIG. 9.

The following provides an overview of aspects of the present disclosure:

Aspect 1: A method for wireless communication at a first UE, comprising: receiving a first control signal that indicates a set of sidelink resources comprising a plurality of slots within a subcarrier, wherein the plurality of slots comprises a first set of symbols allocated for power control signaling and a second set of symbols allocated as gap symbols; receiving, based at least in part on receiving the first control signal, a second control signal comprising an indication of whether to receive a first data signal using one or both of the first set of symbols or the second set of symbols; and receiving the first data signal in accordance with the indication.

Aspect 2: The method of aspect 1, wherein receiving the second control signal comprises: receiving control information scheduling the first UE to receive the first data signal using a first slot of the plurality of slots and a second slot of the plurality of slots, wherein the first slot is before the second slot in time.

Aspect 3: The method of aspect 2, wherein receiving the first data signal comprises: receiving a first portion of the first data signal using a subset of the first set of symbols corresponding to the first slot in accordance with the indication signaling to receive the first data signal using the first set of symbols.

Aspect 4: The method of aspect 3, wherein receiving the first data signal comprises: receiving a second portion of the first data signal using a subset of the first set of symbols corresponding to the second slot in accordance with the indication signaling to receive the first data signal using the first set of symbols.

Aspect 5: The method of any of aspects 2 through 4, wherein receiving the first data signal comprises: receiving a first portion of the first data signal using a subset of the second set of symbols corresponding to the second slot in accordance with the indication signaling to receive the first data signal using the second set of symbols.

Aspect 6: The method of aspect 5, wherein receiving the first data signal comprises: receiving a second portion of the first data signal using a subset of the second set of symbols corresponding to the first slot in accordance with the indication signaling to receive the first data signal using the second set of symbols.

Aspect 7: The method of any of aspects 2 through 6, wherein the first slot is associated with a first FDRA and the second slot is associated with a second FDRA different from the first FDRA, and the second control signal comprises a first bit indicating whether to receive a first portion of the first data signal using a subset of the first set of symbols corresponding to the first slot, a second bit indicating whether to receive a second portion of the first data signal using a subset of the second set of symbols corresponding to the first slot, a third bit indicating whether to receive a third portion of the first data signal using a subset of the first set of symbols corresponding to the second slot, and a fourth bit indicating whether to receive a fourth portion of the first data signal using a subset of the second set of symbols corresponding to the second slot.

Aspect 8: The method of any of aspects 1 through 6, wherein the second control signal comprises a first bit indicating whether to receive a first a portion of the first data signal using the first set of symbols and a second bit indicating whether to receive a second portion of the first data signal using the second set of symbols.

Aspect 9: The method of aspect 2, wherein receiving the second control signal comprises: receiving first control information scheduling the first UE to receive the first data signal using one or more first slots of the plurality of slots and second control information scheduling a second UE to receive a second data signal using one or more second slots of the plurality of slots.

Aspect 10: The method of aspect 9, wherein the second control signal comprises an indication of whether to receive the second data signal using one or both of the first set of symbols or the second set of symbols.

Aspect 11: The method of any of aspects 9 and 10, wherein the second control signal comprises a first bit indicating whether to receive a first portion of the first data signal using a first subset of the first set of symbols, a second bit indicating whether to receive a second portion of the first data signal using a first subset of the second set of symbols, a third bit indicating whether to receive a first portion of the second data signal using a second subset of the first set of symbols, and a fourth bit indicating whether to receive a second portion of the second data signal using a second subset of the second set of symbols.

Aspect 12: The method of any of aspects 1 through 11, wherein a subset of the plurality of slots comprises a third set of symbols allocated for sidelink feedback, and wherein receiving the first data signal comprises: receiving the first data signal using a subset of the second set of symbols corresponding to a slot of the subset of slots in accordance with the indication signaling to receive the first data signal using the second set of symbols.

Aspect 13: The method of any of aspects 1 through 12, wherein a subset of the plurality of slots comprises a third set of symbols allocated for sidelink feedback, the method further comprising: receiving filler signaling using a subset of the second set of symbols corresponding to a slot of the subset of slots.

Aspect 14: The method of any of aspects 1 through 13, wherein the second control signal comprises type 1 SCI or type 2 SCI.

Aspect 15: A method for wireless communication at a first UE, comprising: receiving a first control signal that indicates a set of sidelink resources comprising a plurality of slots within a subcarrier, wherein the plurality of slots comprises a first set of symbols allocated for power control signaling and a second set of symbols allocated as gap symbols; transmitting, based at least in part on receiving the first control signal, a second control signal comprising an indication of whether a second UE is to receive a first data signal using one or both of the first set of symbols or the second set of symbols; and transmitting the first data signal in accordance with the indication.

Aspect 16: The method of aspect 15, wherein transmitting the second control signal comprises: transmitting control information scheduling the second UE to receive the first data signal using a first slot of the plurality of slots and a second slot of the plurality of slots, wherein the first slot is before the second slot in time.

Aspect 17: The method of aspect 16, wherein transmitting the first data signal comprises: transmitting a first portion of the first data signal using a subset of the first set of symbols corresponding to the first slot in accordance with the indication signaling the second UE to receive the first data signal using the first set of symbols.

Aspect 18: The method of aspect 17, wherein transmitting the first data signal comprises: transmitting a second portion of the first data signal using a subset of the first set of symbols corresponding to the second slot in accordance with the indication signaling the second UE to receive the first data signal using the first set of symbols.

Aspect 19: The method of any of aspects 16 through 18, wherein transmitting the first data signal comprises: transmitting a first portion of the first data signal using subset of the second set of symbols corresponding to the second slot in accordance with the indication signaling the second UE to receive the first data signal using the second set of symbols.

Aspect 20: The method of aspect 19, wherein transmitting the first data signal comprises: transmitting a second portion of the first data signal using a subset of the second set of symbols corresponding to the first slot in accordance with the indication signaling the second UE to receive the first data signal using the second set of symbols.

Aspect 21: The method of any of aspects 16 through 20, wherein the first slot is associated with a first FDRA and the second slot is associated with a second FDRA different from the first FDRA, and the second control signal comprises a first bit indicating whether the second UE is to receive a first portion of the first data signal using a subset of the first set of symbols corresponding to the first slot, a second bit indicating whether the second UE is to receive a second portion of the first data signal using a subset of the second set of symbols corresponding to the first slot, a third bit indicating whether the second UE is to receive a third portion of the first data signal using a subset of the first set of symbols corresponding to second slot, and a fourth bit indicating whether the second UE is to receive a fourth portion of the first data signal using a second subset of the second set of symbols corresponding to the second slot.

Aspect 22: The method of any of aspects 15 through 20, wherein the second control signal comprises a first bit indicating whether the second UE is to receive a first portion the first data signal using the first set of symbols and a second bit indicating whether the second UE is to receive a second portion of the first data signal using the second set of symbols.

Aspect 23: The method of any of aspects 15 through 22, wherein transmitting the second control signal comprises: transmitting first control information scheduling the second UE to receive the first data signal using one or more first slots of the plurality of slots and second control information scheduling a third UE to receive second data signal using one or more second slots of the plurality of slots.

Aspect 24: The method of aspect 23, wherein the second control signal comprises an indication of whether the third UE is to receive the second data signal using one or both of the first set of symbols or the second set of symbols.

Aspect 25: The method of any of aspects 23 and 24, wherein the second control signal comprises a first bit indicating whether the second UE is to receive a first portion of the first data signal using a first subset of the first set of symbols, a second bit indicating whether the second UE is to receive a second portion of the first data signal using a first subset of the second set of symbols, a third bit whether the third UE is to receive a first portion of the second data signal using a second subset of the first set of symbols, and a fourth bit indicating whether the third UE is to receive a second portion of the second data signal using a second subset of the second set of symbols.

Aspect 26: The method of any of aspects 15 through 25, wherein subset of the plurality of slots comprises a third set of symbols allocated for sidelink feedback, and wherein transmitting the first data signal comprises: transmitting the first data signal using a subset of the second set of symbols corresponding to a slot of the subset of slots in accordance with the indication signaling the second UE receive the first data signal using the second set of symbols.

Aspect 27: The method of any of aspects 15 through 26, wherein a subset of the plurality of slots comprises a third set of symbols allocated for sidelink feedback, the method further comprising: transmitting filler signaling using a subset of the second set of symbols corresponding to a slot of the subset of slots.

Aspect 28: The method of any of aspects 15 through 27, wherein the second control signal comprises type 1 SCI or type 2 SCI.

Aspect 29: An apparatus for wireless communication at a first UE, comprising a processor; memory coupled with the processor; and instructions stored in the memory and executable by the processor to cause the apparatus to perform a method of any of aspects 1 through 14.

Aspect 30: An apparatus for wireless communication at a first UE, comprising at least one means for performing a method of any of aspects 1 through 14.

Aspect 31: A non-transitory computer-readable medium storing code for wireless communication at a first UE, the code comprising instructions executable by a processor to perform a method of any of aspects 1 through 14.

Aspect 32: An apparatus for wireless communication at a first UE, comprising a processor; memory coupled with the processor; and instructions stored in the memory and executable by the processor to cause the apparatus to perform a method of any of aspects 15 through 28.

Aspect 33: An apparatus for wireless communication at a first UE, comprising at least one means for performing a method of any of aspects 15 through 28.

Aspect 34: A non-transitory computer-readable medium storing code for wireless communication at a first UE, the code comprising instructions executable by a processor to perform a method of any of aspects 15 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication at a first user equipment (UE), comprising:
a processor; and
memory coupled with the processor, the memory comprising instructions executable by the processor to cause the apparatus to:
receive a first control signal that indicates a set of sidelink resources comprising a plurality of slots within a subcarrier, wherein the plurality of slots comprises a first set of symbols allocated for power control signaling and a second set of symbols allocated as gap symbols;
receive, based at least in part on receiving the first control signal, a second control signal comprising an indication of whether to receive a first data signal using one or both of the first set of symbols or the second set of symbols; and
receive the first data signal in accordance with the indication.

2. The apparatus of claim 1, wherein the instructions to receive the second control signal are executable by the processor to cause the apparatus to:
receive control information scheduling the first UE to receive the first data signal using a first slot of the plurality of slots and a second slot of the plurality of slots, wherein the first slot is before the second slot in time.

3. The apparatus of claim 2, wherein the instructions to receive the first data signal are executable by the processor to cause the apparatus to:
receive a first portion of the first data signal using a subset of the first set of symbols corresponding to the first slot in accordance with the indication signaling to receive the first data signal using the first set of symbols.

4. The apparatus of claim 3, wherein the instructions to receive the first data signal are executable by the processor to cause the apparatus to:
receive a second portion of the first data signal using a subset of the first set of symbols corresponding to the second slot in accordance with the indication signaling to receive the first data signal using the first set of symbols.

5. The apparatus of claim 2, wherein the instructions to receive the first data signal are executable by the processor to cause the apparatus to:
receive a first portion of the first data signal using a subset of the second set of symbols corresponding to the second slot in accordance with the indication signaling to receive the first data signal using the second set of symbols.

6. The apparatus of claim 5, wherein the instructions to receive the first data signal are executable by the processor to cause the apparatus to:
receive a second portion of the first data signal using a subset of the second set of symbols corresponding to the first slot in accordance with the indication signaling to receive the first data signal using the second set of symbols.

7. The apparatus of claim 2, wherein the first slot is associated with a first frequency domain resource allocation and the second slot is associated with a second frequency domain resource allocation different from the first frequency domain resource allocation, and wherein the second control signal comprises a first bit indicating whether to receive a first portion of the first data signal using a subset of the first set of symbols corresponding to the first slot, a second bit indicating whether to receive a second portion of the first data signal using a subset of the second set of symbols corresponding to the first slot, a third bit indicating whether to receive a third portion of the first data signal using a subset of the first set of symbols corresponding to the second slot, and a fourth bit indicating whether to receive a fourth portion of the first data signal using a subset of the second set of symbols corresponding to the second slot.

8. The apparatus of claim 1, wherein the second control signal comprises a first bit indicating whether to receive a first a portion of the first data signal using the first set of symbols and a second bit indicating whether to receive a second portion of the first data signal using the second set of symbols.

9. The apparatus of claim 1, wherein the instructions to receive the second control signal are executable by the processor to cause the apparatus to:
receive first control information scheduling the first UE to receive the first data signal using one or more first slots of the plurality of slots and second control information scheduling a second UE to receive a second data signal using one or more second slots of the plurality of slots.

10. The apparatus of claim 9, wherein the second control signal comprises an indication of whether to receive the second data signal using one or both of the first set of symbols or the second set of symbols.

11. The apparatus of claim 9, wherein the second control signal comprises a first bit indicating whether to receive a first portion of the first data signal using a first subset of the first set of symbols, a second bit indicating whether to receive a second portion of the first data signal using a first subset of the second set of symbols, a third bit indicating whether to receive a first portion of the second data signal using a second subset of the first set of symbols, and a fourth bit indicating whether to receive a second portion of the second data signal using a second subset of the second set of symbols.

12. The apparatus of claim 1, wherein a subset of the plurality of slots comprises a third set of symbols allocated for sidelink feedback, and wherein the instructions to receive the first data signal are executable by the processor to cause the apparatus to:
receive the first data signal using a subset of the second set of symbols corresponding to a slot of the subset of slots in accordance with the indication signaling to receive the first data signal using the second set of symbols.

13. The apparatus of claim 1, wherein a subset of the plurality of slots comprises a third set of symbols allocated for sidelink feedback, and wherein the instructions are further executable by the processor to cause the apparatus to:
receive filler signaling using a subset of the second set of symbols corresponding to a slot of the subset of slots.

14. The apparatus of claim 1, wherein the second control signal comprises type 1 sidelink control information or type 2 sidelink control information.

15. An apparatus for wireless communication at a first user equipment (UE), comprising:
a processor; and
memory coupled with the processor, the memory comprising instructions executable by the processor to cause the apparatus to:
receive a first control signal that indicates a set of sidelink resources comprising a plurality of slots within a subcarrier, wherein the plurality of slots comprises a first set of symbols allocated for power control signaling and a second set of symbols allocated as gap symbols;
transmit, based at least in part on receiving the first control signal, a second control signal comprising an indication of whether a second UE is to receive a first data signal using one or both of the first set of symbols or the second set of symbols; and
transmit the first data signal in accordance with the indication.

16. The apparatus of claim 15, wherein the instructions to transmit the second control signal are executable by the processor to cause the apparatus to:
transmit control information scheduling the second UE to receive the first data signal using a first slot of the plurality of slots and a second slot of the plurality of slots, wherein the first slot is before the second slot in time.

17. The apparatus of claim 16, wherein the instructions to transmit the first data signal are executable by the processor to cause the apparatus to:
transmit a first portion of the first data signal using a subset of the first set of symbols corresponding to the first slot in accordance with the indication signaling the second UE to receive the first data signal using the first set of symbols.

18. (canceled)

19. The apparatus of claim 16, wherein the instructions to transmit the first data signal are executable by the processor to cause the apparatus to:
transmit a first portion of the first data signal using subset of the second set of symbols corresponding to the second slot in accordance with the indication signaling the second UE to receive the first data signal using the second set of symbols.

20-21. (canceled)

22. The apparatus of claim 15, wherein the second control signal comprises a first bit indicating whether the second UE is to receive a first portion the first data signal using the first set of symbols and a second bit indicating whether the second UE is to receive a second portion of the first data signal using the second set of symbols.

23. The apparatus of claim 15, wherein the instructions to transmit the second control signal are executable by the processor to cause the apparatus to:
transmit first control information scheduling the second UE to receive the first data signal using one or more first slots of the plurality of slots and second control information scheduling a third UE to receive second data signal using one or more second slots of the plurality of slots.

24-30. (canceled)
